(19) United States
(12) Patent Application Publication
(10) Pub. No.: US 2023/0057699 A1
(43) Pub. Date: Feb. 23, 2023

(54) NANOTECHNOLOGY-BASED PESTICIDES AND INTERMEDIATES, COMPOSITIONS AND TREATMENTS USING THE SAME

(71) Applicant: East Carolina University, Greenville, NC (US)

(72) Inventor: Lok Raj Pokhrel, Greenville, NC (US)

(21) Appl. No.: 17/759,260

(22) PCT Filed: Jan. 21, 2021
(86) PCT No.: PCT/US2021/014343

§ 371 Date: Jul. 21, 2022

Related U.S. Application Data
(60) Provisional application No. 62/964,368, filed on Jan. 22, 2020.

(51) Int. Cl. A01N 25/28; A01N 59/16; A01P 7/04; A01P 1/00

(52) U.S. Cl. CPC A01N 25/28; A01N 59/16; A01P 7/04; A01P 1/00

(57) ABSTRACT

The present inventive concept is related to metal nanoparticles, such as silver (Ag) nanoparticles, including a metal core and a surface to the metal core functionalized with a positively charged molecule/polymer coating the surface such as amino (—NH₂), amide ([C═O]—N), polyethyleneimine/branched polyethyleneimine (PEI/BPEI), pesticidal compositions including the metal nanoparticle, and methods of using the pesticidal compositions including the metal nanoparticle.

### CROSS-REFERENCE TO RELATED APPLICATION

The present application claims the benefit of U.S. Provisional Patent Application No. 62/964,368, filed Jan. 22, 2020, the disclosure of which is incorporated herein by reference in its entirety.

### COPYRIGHT

This disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD

The present inventive concept provides a nanotechnology-based composition that is effective against pests and against microbial organisms.

### BACKGROUND

According to verified market research, the global vector control market was valued at USD 15.10 billion in 2018 and is projected to reach USD 22.23 billion by 2026, growing at a CAGR of 4.92% from 2019 to 2026 (ref. [1]). Of the >2 million tons of pesticides applied annually, insecticides constitute about one-third of the global pesticide use; of this about 25% are used in the United States (refs. [2,3]). Despite significant amounts of insecticides being used globally, up to 100 million infections of dengue and 219 million cases of malarial fever were estimated in 2017 (refs. [4,5]). In addition to birth defects, developmental delays, neurological disorders, decreased lung functions and cancer among applicators and children (refs. [6-16]), increased ecological and economic burden and toxicities to the non-target species and humans have been linked to ever-growing pesticide applications and their environmental persistence and bioaccumulation (refs. [17,18]). Constant selective pressures from the highly toxic legacy insecticides (e.g., organophosphates, pyrethroids, carbamates) have further promoted insecticide resistance (IR) among insects and mosquito populations worldwide (refs. [19-21]). Additionally, potential non-target ecological effects of some mosquito repellents, such as DEET, are known to promote mosquito populations due to predator loss (refs. [22]). These factors, coupled with mosquito egg resistance to desiccation (refs. [23]), increasing adaptation around the megacities/human dwellings, and warming climate underscore the need to control Aedes and other mosquito populations and the debilitating diseases, such as dengue, Zika, yellow fever, malaria and West Nile fevers, among others, that the mosquitos transmit to humans (refs. [4,24]).

The global antibiotics market size is expected to reach USD 62.06 billion by 2026, expanding at a CAGR of 4.0%, according to a report by Grand View Research, Inc (refs. [25]). The World Health Organization (WHO) and the Centers for Disease Control (CDC) have recognized antibiotic resistance (AR) among microbes as the biggest threat to global public health, costing over 1.5 billion to the US economy alone (refs. [26,27]). Hospital-acquired infections (HAIs), also called nosocomial infections, are detrimental to patient safety and recovery. HAIs are a threat in all hospitals, but the intensive care unit (ICU) has the highest rates of HAIs ([ref. [28]). Moreover, HAIs are most common with the central line bloodstream and ventilator usage costing an extra 9.5 and 9.1 days of hospital stay, respectively ([ref. [29]). Annually, over 12 million deaths occur due to HAIs globally, of which 95% occur in low-to-middle income countries (LMICs) ([ref. [30]). In the US, in particular, at least 2 million people contract an AR infection, and at least 23,000 people die as a result. Almost all bacteria that infect humans are known to develop AR, bypassing the effect of antibiotics and/or multiple drugs, often dubbed as multidrug resistance (MDR). Globally, it is estimated that AR/MDR could kill 10 million people annually by 2050, with an estimated 100 trillion US dollars lost in economic output (ref.) [31]). Hence, there is an increased demand for new generation antibiotics that can address the imminent threat of AR/MDR and protect public health from infections and sepsis associated with HAIs.

### SUMMARY

The present inventive concept provides nonporous nano-metal organic frameworks (NN-MOF) having antimicrobial, antifungal and/or pesticidal capabilities and intermediates, compositions and methods of making the same, as well as treatments and safety of using the same.

In some embodiments, the present inventive concept provides an aqueous-based suspension of positively charged amino (—NH₂)-ligand surface functionalized metal nanoparticles. In some embodiments, the amino (—NH₂)-surface functionalized metal nanoparticles have a mean TEM diameter of, for example, about 5.8±2.8 nm, and/or an average hydrodynamic diameter (HDD) of about 4.3 nm±1.3 nm. In some embodiments, the amino (NH₂)-ligand layer alone has a thickness in the range of, for example, about 0.5-1.5 nm around the core metal nanoparticles. In some embodiments, the amino (NH₂)-ligand layer with a thickness in the range of about 0.5-1.5 nm surrounds the core metal nanoparticles of elemental/metallic silver (Ag⁰). In some embodiments, the amino (—NH₂)-surface functionalized metal nanoparticles have a positive zeta potential of, for example, around +41 mV. In some embodiments, the amino (—NH₂)-surface functionalized metal nanoparticles are highly stable at room temperature, and thus, there is no need for refrigeration during transportation or storage.

Accordingly, in an aspect of the present inventive concept, provided is a nanoparticle including: a metal or metal oxide core; and a surface of the core functionalized with a positively charged molecule/polymer coating the surface, wherein the positively charged molecule/polymer includes amino (—NH₂) functional groups. In some aspects, the core may be a metal core, may include silver (Ag), and/or may be nonporous. Also provided are pesticidal compositions including the nanoparticles as described herein.

In another aspect of the inventive concept, provided is a method of preparing a metal nanoparticle including: subjecting a mixture of a metal salt and a molecule/polymer including amino (—NH₂) functional groups in a buffered aqueous solution to ultraviolet (UV) light exposure and heat; adding a reducing agent to the mixture; and optionally purifying the metal nanoparticle, to synthesize a metal nanoparticle, wherein the metal nanoparticle includes a metal core and a functionalized surface decorated with positively charged molecule/polymer coating the surface. Also provided are pesticidal compositions including the metal nanoparticle prepared as described herein.

According to another aspect of the inventive concept, provided is a method of controlling pests including applying the pesticidal composition as described herein to the pest, or to a subject, a substrate and/or an environment in which the pest may be found, and a method of controlling or reducing disease transmission through a pest including exposing the pest, or exposing a subject, a substrate or an environment in which the pest may be found, to the pesticidal compositions including the metal nanoparticle as described herein.

### BRIEF DESCRIPTION OF THE DRAWINGS

FIG. 1 depicts transmission electron microscopy (TEM) images of (panels A, B), and energy dispersive X-ray spectroscopy (EDS) (panel C) for NoPest-Ag5. Size distribution of NoPest-Ag5 particles is depicted in panel D.

FIG. 2 depicts X-ray photoelectron spectroscopy (XPS) scans for Ag (3d) (panel A) and N (1s) (panel B) of NoPest-Ag5.

FIG. 3 depicts additional TEM images of NoPest-Ag5.

FIG. 4 depicts a scanning electron microscopy (STEM) darkfield mode image of NoPest-Ag5.

FIG. 5 depicts an electron diffraction pattern obtained by FFT of the image area shown by the circle (1) in FIG. 4.

FIG. 6 depicts scanning electron microscopy (SEM) images of Aedes aegypti eggs exposed to 0.5 mg/L NH₂—AgNPs (panels A, B, C) and 0.5 mg/L Ag⁺ ions (panels D, E, F; used as positive control).

FIG. 7 depicts SEM images of Aedes aegypti eggs exposed to 0.05 mg/L NH₂—AgNPs (panel A), 100 mg/L NH₂—AgNPs (panel B), and 0.05 mg/L Ag⁺ ions (C, D; used as positive control).

FIG. 8 depicts the antimicrobial effects of positively charged NH₂—AgNPs compared with carboxylate/citrate AgNPs (cit-AgNPs) and Ag⁺ ions on E. coli DH5α and K12 growth (panel A), and the effects of the surface interaction of 10 mg/L (equivalent to 10 ppm) NH₂—AgNPs compared with the effects of the surface interaction of Cit-AgNPs and Ag⁺ ions on E. coli DH5α (panel B).

FIG. 9 depicts Silver body burden in eggs (panel A) and adults (panel B) of Aedes aegypti mosquito upon exposure to 0.5 mg/L NH₂—AgNPs or 0.5 mg/L Ag⁺ ions (positive control). ‘Con’ denotes negative controls (water+food). SE denotes standard error of the means.

FIG. 10 depicts the effect of ˜5 nm NH₂—AgNPs exposure to human HeLa cells.

FIG. 11 depicts the interaction with soybean seeds exposed to 5 nm NH₂—AgNPs.

FIG. 12 depicts the effect exposure to NH₂—AgNPs on soybean seed germination.

FIG. 13 depicts the effect of exposure to NH₂—AgNPs on soybean seedling biomass.

FIG. 14 depicts the effect of exposure of NH₂—AgNPs on corn seed germination.

FIG. 15 depicts the fate of NH₂—AgNPs in water containing NPK (20% Nitrogen, 20% Phosphorus, 20% Potassium) fertilizer resulting from coalescence, i.e., similar size particles coalesce/combine to form a larger particle (panel A), and Ostwald's ripening (dissimilar size particles combine to form a larger particle) (panel B).

FIG. 16 depicts Aedes aegypti: Egg-hatch rate (%) (panel A); adult emergence from exposed eggs (%) (panel B); and metamorphosis into adults from 1^{st} instar and 3^{rd} instar larvae exposed at 0.5 mg/L NH₂—AgNPs and their survival % (panel C). ‘Con’ denotes negative controls (water+food). Egg hatching experiments were conducted for 21 days (when hatching was delayed with treatments). Larvae experiments were conducted for 25 days.

FIG. 17 depicts an overview of inhibition of egg-hatch, larvae, pupae and adult emergence of Aedes aegypti upon exposure to 0.5 mg/L NH₂—AgNPs. For details, refer to FIG. 16 and Example 6.

FIG. 18 depicts the comparative toxicity of NH₂—AgNPs and Novaluron (Rimon® 10 EC) on eggs, larvae, pupae and adults on Aedes aegypti.

FIG. 19 depicts a schematic for a representative one-pot protocol for preparing NoPest-Ag5.

FIG. 20 depicts microscopic analysis of the cell count in green alga (Pseudokirchneriella subcapitata) exposed to NoPest-Ag5 (panel B), its ionic counterpart Ag⁺ ions (panel C), Cadmium (Cd²⁺) ions (EPA positive control; panel D), and a neonicotinoid pesticide Imidacloprid (panel E), as a function of concentrations and time. Control group (panel A) received only growth medium (100 mL). Each treatment received 1.2×10⁶ cells/mL on day-0 and were allowed to grow until day-28 when the experiments were halted. Cell count was recorded on day-7 (acute), day-14 and day-28 (chronic).

FIG. 21 depicts total chlorophyll (chlorophyll [a+b]) analysis in green alga (Pseudokirchneriella subcapitata) exposed to NoPest-Ag5 (panel B), its ionic counterpart Ag⁺ ions (panel C), Cadmium (Cd²⁺) ions (EPA positive control; panel D), and a neonicotinoid pesticide Imidacloprid (panel E), as a function of concentrations and time. Control group (panel A) received only growth medium (100 mL). Chlorophylls (a and b) were extracted using a 95% ethanol method and measured using an UV-Vis spectrophotometer (Hach DR6000). Each treatment received 1.2×10⁶ cells/mL on day-0 and were allowed to grow until day-28 when the experiments were halted. Chlorophylls were recorded on day-7 (acute), day-14 and day-28 (chronic).

FIG. 22 depicts a Daphnia magna 48-hour (acute) toxicity test. It shows NoPest-Ag5 (panel B) was nontoxic (mean survival: 93.3-100%) at all concentrations tested (p>0.05). Dissolved Ag⁺ ions (panel C) were also found to be not significantly toxic (mean survival: 66.6-100%) at all concentrations tested compared to the control group (p>0.05). Imidacloprid (panel D) was found to be more toxic (mean survival: 66.6-86.6%) than NoPest-Ag-5 and Ag⁺ ions; however, at 0.5 and 1 mg/L Imidacloprid was significantly less toxic than 0.5 mg/L Cu²⁺ ions (panel E, p<0.0001). Overall, at 0.5 mg/L Cu²⁺ ions were significantly more toxic (mean survival: 0%) than all other compounds tested at comparable concentration. ‘*’ above the bar denotes significantly different from the control (panel A, Con) group at p<0.05.

FIG. 23 depicts a Daphnia magna 21-day (chronic) reproduction test. It shows NoPest-Ag5 was stimulatory (mean increase in reproduction in the range: 246.6-646.6%) up to 0.5 mg/L concentrations (panel B). However, at 1 mg/L of NoPest-Ag5 there was 100% death and thus no reproduction occurred (panel B). Dissolved Ag⁺ ions were also found to be stimulatory (mean increase in reproduction in the range: 126.6-1120%), except at the lowest concentration of 0.01 mg/L that inhibited reproduction (mean decrease in reproduction: 6.6%) (panel C). Imidacloprid group had reproduction not significantly different from control (p>0.1) (panel D). ‘*’ above the bar denotes significantly different from the control (panel A, Con) group.

### DETAILED DESCRIPTION

The foregoing and other aspects of the present inventive concept and the terminology used in the description of the inventive concept herein are for the purpose of describing particular embodiments only and are not intended to be limiting of the inventive concept. As used in the description of the inventive concept and the appended claims, the singular forms “a”, “an” and “the” are intended to include the plural forms as well, unless the context clearly indicates otherwise. Additionally, as used herein, the term “and/or” includes any and all combinations of one or more of the associated listed items and may be abbreviated as “/”.

The term “comprise,” as used herein, in addition to its regular meaning, may also include, and, in some embodiments, may specifically refer to the expressions “consist essentially of” and/or “consist of.” Thus, the expression “comprise” can also refer to, in some embodiments, the specifically listed elements of that which is claimed and does not include further elements, as well as embodiments in which the specifically listed elements of that which is claimed may and/or does encompass further elements, or embodiments in which the specifically listed elements of that which is claimed may encompass further elements that do not materially affect the basic and novel characteristic(s) of that which is claimed. For example, that which is claimed, such as a composition, formulation, method, system, etc. “comprising” listed elements also encompasses, for example, a composition, formulation, method, kit, etc. “consisting of,” i.e., wherein that which is claimed does not include further elements, and a composition, formulation, method, kit, etc. “consisting essentially of,” i.e., wherein that which is claimed may include further elements that do not materially affect the basic and novel characteristic(s) of that which is claimed.

Unless otherwise defined, all technical and scientific terms used herein have the same meaning as commonly understood by one of ordinary skill in the art to which this inventive concept belongs.

The present inventive concept provides a technology that kills pests, such as mosquitos, and microbial pathogens. It can act at a low-dose and inhibits pathogens via electrostatic cell-surface interactions (i.e., nano-bio interactions). Significant electrostatic interactions on the cell surface interface may involve smaller particle sizes (˜5 nm) and higher positive surface charge (+41 mV) of the nanoparticle composition.

Unlike current pesticides, antibiotics, and antifungals that are becoming obsolete at least due to the growing resistance exhibited in pest, such as mosquitos, microbes, and fungi, respectively, the present inventive concept has shown significant potential for pest, microbial, and fungal control applications. Specifically, the present inventive concept is a novel, nanotechnology-based compound, which possesses some, if not all, of the following properties:
a. Water-based, hence more sustainable compared to organic solvents or oil based;
b. Easily scalable to meet commercial demands;
c. Highly stable at room temperature with potential shelf life of over 3 yrs.
d. Acts via electrostatic cell-surface interactions, so the mosquitos and microbes may not develop resistance;
e. Low dose application, hence economical to use and reduce overall chemical burden in the environment;
f. May be broad-spectrum, and may effectively work against other mosquito and microbial species;
g. Safer to non-target organisms including human cells, crop plants, honeybees, daphnids and algae at doses that are toxic to mosquitos and microbes; and
h. Significantly lower biouptake in mosquitos, suggesting lower risk to nontarget species that prey upon the mosquitos.

### Nanoparticles

Accordingly, in some embodiments, the present inventive concept provides surface-decorated nanoparticles, for example, surface-decorated metal nanoparticles, such as silver (Ag) nanoparticles, the nanoparticles including a core, such as a metal core or a metal oxide core, the core including a surface decorated/coated/covered with molecules/polymers/ligands including a functional group, for example, positively charged functional groups such as amino (—NH₂) functional groups, and/or amide ([C═O]—N) functional groups, adsorbed/directly bound to the surface of the core of the nanoparticle.

According to embodiments of the present inventive concept, nanoparticles, for example, metal nanoparticles, may include a metal core or a metal oxide core, such as a silver (Ag) metal core. In some embodiments, the core may be, for example, a nonporous core and/or a pure crystalline core, such as a pure crystalline Ag core having a face-center cubic (FCC) crystal structure. In some embodiments, the metal core of the nanoparticle is elemental/metallic, such as elemental/metallic silver (Ag⁰). In some embodiments, the metal core of the nanoparticle is elemental/metallic gold (Au⁰). In some embodiments, the core may be a metal oxide core, such as, for example, Ag₂O, ZnO, CuO, or Ce₂O. It will be appreciated that the metal nanoparticles of the inventive concept may be functionalized to include a surface decorated with molecules/polymers/ligands, and the like, that may provide a particular characteristic(s) to the surface of the nanoparticle. For example, the characteristic provided may include positive/negative charge, and/or hydrophobicity/hydrophilicity.

The characteristic(s) of the molecules/polymers/ligands coating/decorating the surface of the nanoparticle, such as a metal/Ag nanoparticle, may provide charge and/or hydrophobicity/hydrophilicity to the nanoparticle. For example, a negative charge may be provided by coating or decorating the metal/Ag nanoparticle with, for example, a carboxylate group including molecules/polymers/ligands, such as carbonate, citrate, or polymers such as polyvinylpyrrolidone (PVP). A positive charge may be provided by coating Ag nanoparticles with, for example, a molecule/polymer/ligand containing amino groups, such as aminated silica, or polyethyleneimine (PEI), for example, branched polyethyleneimine (BPEI) or linear polyethyleneimine (LPEI). In some embodiments, Ag nanoparticles in the size ranges as set forth as follows, are coated with BPEI in the thicknesses as set forth as follows.

It will be appreciated that typically, nanoparticles, such as metal nanoparticles, may have diameters of, for example, 1-100 nm, and may include shapes other than spheres, for example, but not limited to rods, triangles, and hexagons, etc. In some embodiments, the nanoparticles of the inventive concept have a size less than about 50 nm, less than about 40 nm, less than about 30 nm, less than about 20 nm, less than about 10 nm, less than about 9 nm, less than about 8 nm, less than about 7 nm, less than about 6 nm, less than about 5 nm, less than about 4 nm, less than about 3 nm, or less than about 2 nm, for example, as determined visibly by transmission electron microscopy (TEM), or hydrodynamically to provide a hydrodynamic diameter/size. In some embodiments, the size of the nanoparticles, such as Ag nanoparticles, may be about 1-20 nm, about 1-15 nm, about 1-10 nm, about 2-10 nm, about 2-9 nm, about 3-9 nm, about 1-8 nm, about 2-8 nm, or 3-8 nm in size as determined by TEM, and may surface decorated/coated/covered with a layer of a molecule/polymer/ligand including a functional group, the layer having a thickness of less than about 2 nm, for example, but not limited to, a layer of the molecule/polymer/ligand, such as PEI/BPEI, having a uniform thickness in a range of about 0.5-1.5 nm layer surrounding a metal core, such as a pure crystalline metal core of Ag, and in some embodiments, a core of elemental/metallic silver (Ag⁰). In some embodiments, direct binding of functional groups, such as amino and/or amide groups from the molecules/polymers/ligands, such as PEI/BPEI, to the core, such as a metal core, results in the molecules/polymers/ligands having a uniform thickness around the core of the nanoparticle. In some embodiments, the nanoparticles, such as Ag nanoparticles, may have a mean size/diameter of about 6 nm, about 5 nm, about 4 nm, or about 3 nm, as determined by TEM. In some embodiments, the nanoparticles, such as Ag nanoparticles, coated with a molecule/polymer/ligand including a functional group(s) may have a mean size/diameter as determined by TEM of about 5.8±about 2.8-2.9 nm, and a spherical or substantially spherical shape.

In some embodiments, nanoparticles of the inventive concept, for example, metal nanoparticles, such as positively charged Ag nanoparticles, have, for example, sizes/diameters in a range of about 1-20 nm, about 1-15 nm, about 1-10 nm, about 2-10 nm, about 2-9 nm, about 3-9 nm, about 1-8 nm, about 2-8 nm, about 3-8 nm, about 3-7 nm, about 3-6 nm, or about 3-5 nm in size/diameter as determined hydrodynamically, and have a mean size/diameter of about 6 nm, about 5 nm, about 4 nm, or about 3 nm. In some embodiments, Ag nanoparticles, coated with a molecule/polymer/ligand including positively charged functional group(s), for example, NH₂/PEI/BPEI, the coating/layer of NH₂/PEI/BPEI may have a uniform thickness of about 0.5-1.5 nm, and the nanoparticles may have a mean hydrodynamic diameter of about 4.3 nm±about 1.3 nm, and a spherical or substantially spherical shape.

In some embodiments, the nanoparticles may include and/or have further characteristics, for example, as measured by polydispersity index, zeta potential/surface charge, electrophoretic mobility, solution conductivity, spectroscopic characteristics, such as peaks/maximums determined by surface plasmon resonance and X-ray photoelectron spectroscopy (XPS), and stability. For example, in some embodiments, Ag nanoparticles of the inventive concept have a polydispersity index (PDI) of about 0.3, a zeta potential/surface charge of about +39.4 mV to about +47.8 mV, an electrophoretic mobility of about 3.157 μm×cm/V×s, a solution conductivity of about 5 μS/cm to about 122 μS/cm, a localized plasmon resonance peak maximum at about 416.5 nm, and/or an Ag (3d) XPS binding energy maximum at about 367.46 eV, a C (1s) XPS binding energy maximum at about 284.76 eV, an N (1s) XPS binding energy maximum at about 398.74 eV, and/or an O (1s) XPS binding energy maximum at about 531.25 eV. In some embodiments, the Ag nanoparticles of the inventive concept may have atomic weight percentages of, for example, about 0.42% Ag, or in a range of about 0.42% Ag to about 1.68% Ag, about 68.49% C, about 11.79% N, and/or about 15.46% O as determined, for example, by XPS analysis. In some embodiments, the Ag nanoparticles of the inventive concept may have a shelf life/stability at room/ambient temperature of at least about 3 years, or greater than 3 years. In some embodiments, the Ag nanoparticles of the inventive concept are devoid of citrate, urea, benzoyl urea, terpenoids, and/or surfactants. In some embodiments, provided are amino (—NH₂) surface-decorated Ag nanoparticles about 5 nm in size (5 nm NH₂—AgNPs). In some embodiments, the —NH₂ surface-decorated Ag nanoparticles (NH₂—AgNPs), such as 5 nm NH₂—AgNPs, may be described as NoPest-Ag5.

In some embodiments, the positively charged molecules/polymers/ligands coating/decorating the surface of the metal/Ag nanoparticles of the inventive concept may include surface ligands in addition to, or in place of —NH₂, such as provided by PEI/BPEI. For example, positively charged surface ligands may be provided by, in part or entirely from, for example, anabasine (3-piperidin-2-ylpyridine; C₁₀H₁₄N₂) and anatabine (1,2,3,6-Tetrahydro-2,3′-bipyridine; C₁₀H₁₂N₂). In some embodiments, NH₂—AgNPs, such as NoPest-Ag5, may include further surface ligands decorated on the parent compound NoPest-Ag5 to provide further derivatives of the parent compound. For example, the additional surface ligand may include oxalylchloride (OC) [ClCOCOCl], dichloroacetate (DCA) [CHCl₂COO⁻], dibromoacetate (DBA) [Br₂CHCOO⁻], difluorobenzamide (DFB) [F₂C₆H₃C(O)NH₂], and/or iodoacetate (IA) [C₂H₂IOO⁻]. In some embodiments, the further derivatives may include any combination of the additional surface ligand or ligands, for example, DCA+DBA, DCA+IA, DBA+IA, and/or DCA+DBA+IA, added to the parent compound, such as an NH₂—AgNP, such as NoPest-Ag5.

The preparation of nanoparticles, for example, metal nanoparticles, such as Ag nanoparticles, of the present inventive concept is not particularly limited, so long as the method used provides nanoparticles, such as metal nanoparticles, having characteristics, for example, size and physical characteristics, as set forth herein. In some embodiments, the method may include mixing in water at room/ambient temperature of a metal salt, such as AgNO₃, the molecule/polymer/ligand providing functional groups to decorate the surface of the Ag nanoparticle core, for example BPEI, and a buffer, for example, HEPES, and exposing the mixture UV light/irradiation for a period of time, for example, 254 nm UV light for about 6 hours, followed by heating to about 95° C. for about 45 minutes. This may be followed by monitoring reduction of Ag⁺ to Ag⁰ by addition of a reducing agent to the mixture, for example, but not limited to, potassium borohydride or sodium borohydride, for about 12 hours at room/ambient temperature. The nanoparticles may then be isolate/purified by dialysis or diafiltration using membranes having a MW cutoff of 10 kD (˜2 nm) or below 10 kD (<2 nm). Exemplary amounts of reagents used in preparation of Ag nanoparticles of the inventive concept are presented below.

| Reagents used | Weight % (w/v) |
|---|---|
| Ag⁺ ions | 0.035-0.07 |
| BPEI | 0.15-0.5 |
| HEPES | 0.25-0.5 |
| KBH₄ or NaBH₄ | 0.0015-0.0045 |

### Vector Control/Pesticides

Embodiments of the present inventive concept further provide preventively and/or curatively active ingredients in the field of pest control, even at low rates of application, which have a very favorable biocidal spectrum. The active ingredients according to the present inventive concept act against all or individual developmental stages of normally sensitive, but also resistant, animal pests, such as insects. The insecticidal activity of the active ingredients according to the present inventive concept can manifest itself directly, i.e., in destruction of the pests, which takes place either immediately or only after some time has elapsed, for example during ecdysis, or indirectly, for example in a reduced oviposition and/or hatching rate.

As used herein, “pest” generally includes, but is not limited to, a biting, sucking, and chewing invertebrates, such as, but not limited to insects. “Pest” includes, but is not limited to, mosquitos, flies (including house, barn, face, bush, and the like), black flies, no-see-ums, deer flies, horse flies, beetles (e.g., Colorado potato beetles and Japanese beetles), gnats, ticks, beer bugs (raspberry beetles), fleas, lice/phyllids, bed bugs, earwigs, ants, cockroaches, aphids, spruce bud worms, corn borers, sand fleas, tsetse flies, mites, assassin bugs, silverfish, moths (e.g., clothes moths and the like), centipedes, stinkbugs, termites, wasps, hornets, stink bugs, locusts, mormon crickets, aphids, whiteflies, corn rootworms, box elder bugs, and the like. The present inventive concept may be used to control pests at various stages of their life cycle, including eggs, larvae, nymphs/pupae and adults.

The present inventive concept may be also used to control any insect pests that may be present in grasses, including for example beetles, caterpillars/larvae to pest lepidoptera, fire ants, ground pearls, millipedes, sow bugs, mites, mole crickets, scale insects, mealybugs ticks, spittlebugs, southern chinch bugs and white grubs.

In the hygiene sector, the compositions according to the present inventive concept are active against ectoparasites such as hard ticks, soft ticks, mange mites, harvest mites, flies (biting and licking), parasitic fly larvae, lice, hair lice, bird lice and fleas.

The compositions according to the present inventive concept may also be used to reduce disease transmission, for example, to reduce the incidence of common insect-borne diseases of humans and other animals. The following are some common examples of insect-borne diseases. Mosquitos may be vectors for malaria, yellow fever, dengue fever, and West Nile encephalitis, Rift Valley fever, Arboviral Encephalitis, such as Eastern equine encephalitis, Japanese encephalitis, La Crosse encephalitis, St. Louis encephalitis, West Nile virus and Western equine encephalitis, and filariasis. Ticks can be vectors for babesiosis, ehrlichiosis, Lyme disease, Rocky Mountain spotted fever, Southern tick-associated rash illness, tick typhus, tularemia, and encephalitis. Sand fleas are vectors for Leishmaniasis, Carrion's disease and sand fly fever. Tsetse flies can be vectors for African sleeping sickness. Assassin bugs may be vectors for Chagas disease. Lice may be vectors for lice infestation, epidemic relapsing fever, trench fever and typhus fever. Black flies may be vectors for filariasis and onchocerciasis. Horse flies and deer flies may be vectors for tularemia, anthrax and loiasis. Eye gnats can be vectors for yaws and conjunctivitis. House flies may be vectors for dysentery, typhoid fever, cholera and poliomyelitis. Rat fleas are carriers of bubonic plague and murine typhus. In addition, various parasitic, rickettsial, bacterial and viral diseases of animals and man are spread by mosquitos, ticks, biting flies, fleas, lice and other biting insects. Compositions of the present inventive concept further help reduce the incidence of the diseases in humans and animals by reducing the number of insect bites.

Mosquitos that may be vectors for disease and/or are considered as pests include, for example, mosquitos of the genus Aedes, Anopheles, Coquillettidia, Culex, Culiseta, Mansonia, Ochlerotatus, Psorophora, Toxorhynchites, Uranotaenia, and/or Wyeomyia. In an exemplary embodiment, mosquitos that may be controlled by the metal nanoparticles, and compositions/formulations including metal nanoparticles of the inventive concept include Aedes aegypti mosquitos.

Compositions/formulations of the present inventive concept can be used for controlling, i.e. containing or destroying, pests of the abovementioned type which occur on plants, such as useful plants and ornamentals in agriculture including crops, in horticulture and in forests, or on organs, such as fruits, flowers, foliage, stalks, tubers or roots, of such plants, and in some cases even plant organs which are formed at a later point in time remain protected against these pests.

Particular crops, such as food crops and feed crops include, but are not limited to, cereals, such as wheat, barley, rye, oats, rice, maize or sorghum; beet, such as sugar or fodder beet; fruit and fruit trees, for example pomaceous fruit, stone fruit or soft fruit, such as apples, pears, plums, peaches, almonds, cherries or berries, for example strawberries, raspberries or blackberries; leguminous crops, such as beans, lentils, peas or soya; oil crops, such as oilseed rape, mustard, poppies, olives, sunflowers, coconut, castor, cocoa or ground nuts; cucurbits, such as pumpkins, cucumbers or melons; fiber plants/crops and industrial crops, such as cotton, flax, hemp or jute; citrus fruit and citrus fruit trees, such as oranges, lemons, grapefruit or tangerines; vegetables, such as spinach, lettuce, asparagus, cabbages, carrots, onions, tomatoes, potatoes or bell peppers; Lauraceae, such as avocado, Cinnamomum, or camphor; and also tobacco, nuts, coffee, eggplants, sugarcane, tea, pepper, grapevines, hops, the plantain family, and latex plants and/or latex trees.

The compositions of the present inventive concept can be generally formulated in various ways using formulation adjuvants, such as carriers, solvents, and surface-active substances. The formulations can be in various physical forms; e.g., in the form of dusting powders, gels, wettable powders, water-dispersible granules, briquets, water-dispersible tablets, effervescent pellets, emulsifiable concentrates, microemulsifiable concentrates, oil-in-water emulsions, oil-flowables, aqueous dispersions, oily dispersions, suspo-emulsions, capsule suspensions, emulsifiable granules, soluble liquids, water-soluble concentrates (with water or a water-miscible organic solvent as carrier), impregnated polymer films or in other forms known; e.g., from the Manual on Development and Use of FAO and WHO Specifications for Pesticides, United Nations, First Edition, Second Revision (2010). Such formulations can either be used directly or diluted prior to use. The dilutions can be made, for example, with water, liquid fertilizers, micronutrients, biological organisms, oil or solvents.

The metal nanoparticles/compositions of the inventive concept may be provided in amounts/at concentrations sufficient to, for example, inhibit pest eggs from hatching, such as Ae. aegypti mosquito eggs. Additionally, it will be appreciated that concentrations at which nanoparticles/compositions of the inventive concept are effective at vector control must also be environmentally safe/non-toxic. In some embodiments, the eggs, larvae, and/or pupae of pests, for example, Ae. aegypti mosquitos, may be exposed to an effective amount of the nanoparticles of the inventive concept. It will be appreciated that exposure to an effective amount may lead to essentially 100% egg death, with no metamorphosis and adult mosquito emergence. Exposure to an effective amount may include exposure to compositions/formulations including about 0.005 mg/L (ppm), about 0.05 mg/L, about 0.1 mg/L about 0.25 mg/L, about 0.5 mg/L, about 1 mg/L, about 5 mg/L, about 10 mg/L, about 20 mg/L, and/or about 50 mg/L (total Ag), or any amount between about 0.005-50 mg/L, of the nanoparticles of the inventive concept.

By environmentally safe/non-toxic, it will be appreciated that nanoparticles, and compositions and/or formulations including nanoparticles of the inventive concept will have no, or little significant impact on the natural environment, such as water and soil, and have little or no significant deleterious effects (e.g., sicken and/or kill) on off-target organisms, such as desirable flora and fauna within the natural environment, such as crops, for example, soybeans and corn, and beneficial insects, such as beneficial insect pollinators, small crustaceans/shellfish (e.g., edible shellfish), food crops, feed crops, fiber crops, industrial crops, oil crops, ornamental crops, and fruit trees. In some embodiments, the off-target organisms are beneficial insect pollinators, for example, honeybees and the like. In some embodiments, the off-target organisms to which the metal nanoparticles, and compositions and/or formulations including the nanoparticles of the inventive concept are non-toxic include honeybees (Apis mellifera, Apis dorsata, Apis cerana, Apis koshevnicovi, Apis nigrocincta, Apis florea, Apis andreniformis, and Apis laboriosa). In some embodiments, the off-target organisms to which the metal nanoparticles, and compositions and/or formulations including the nanoparticles of the inventive concept are non-toxic include daphnia (Daphnia magna, Daphnia pulex, Daphnia longispina, Daphnia coronata, Daphnia lumholtzi, Daphnia barbata, Daphnia galeata, Daphnia nivalis, Daphnia jollyi, and Daphnia occidentalis, etc.). In some embodiments, the off-target organisms to which the metal nanoparticles, and compositions and/or formulations including the nanoparticles of the inventive concept are non-toxic include corn (Zea mays), and/or soybeans (Glycine max).

In some embodiments, the nanoparticles, and compositions and/or formulations including nanoparticles of the inventive concept exhibit lower total Ag body burden (uptake) in eggs, larvae, pupae and/or adult pests, such as mosquitos, i.e., will result in lower transfer of nanoparticles and/or compositions/formulations including nanoparticles of the inventive concept species higher of the environmental food chain, for example, fish and/or birds to which mosquitos are a prominent food source. Thus, nanoparticles and compositions/formulations including nanoparticles of the inventive concept have a lesser environmental impact than conventional vector control compositions/formulations.

### Antimicrobials/Antibiotics/Antifungals

Embodiments of the present inventive concept further provide preventively and/or active ingredients in the field of antimicrobials and/or antibiotics. For example, exposure to an effective amount of the nanoparticle and/or compositions/formulations including nanoparticles of the inventive concept, for example, exposure to compositions/formulations including about 0.005 mg/L (ppm), about 0.05 mg/L, about 0.1 mg/L, about 0.25 mg/L, about 0.5 mg/L, about 1 mg/L, about 5 mg/L, about 10 mg/L, about 20 mg/L, and/or about 50 mg/L (total Ag), or any amount between about 0.005-50 mg/L, of the nanoparticles of the inventive concept, are effective in acting as an antimicrobial, inhibiting and/or preventing growth of gram-negative bacteria, for example, Acinetobacter, Bdellovibrae, Bordetella, Brucella, Citrobacter, Edwardsiella. Enterobacter, Escherichia, Helicobacter, Klebsiella, Legionella, Moraxella, Neisseria, Pasteurella, Proteus, Providencia, Pseudomonas, Salmonella, Serratia, Shigella, Stenotrophomonas, Vibrio, and Yersinia, and the like, and may be effective as a broad spectrum antibiotic against antibiotic resistant (AR) and multidrug resistant (MDR) bacteria or microbial organisms. In some embodiments, the gram-negative bacteria may be a strain of E. coli, such as, but not limited to, E. coli K-12 and DH5α. In some embodiments, the nanoparticles of the inventive concept are effective as an antifungal, for example, against fungi, such as, but not limited to Laccaria, Diplocarpan, Aspergillus and Candida, for example, Candida auris.

### EXAMPLES

Some aspects of the present inventive concept are described in more detail in the following non-limiting Examples. These examples are for illustration purposes and are not to be construed as limiting this disclosure to only the embodiments disclosed in these examples and may be modified within the range not deviating from the true spirit and scope of the inventive concept.

### Example 1

### Physicochemical Properties—NoPest-Ag5

State: Pure Crystalline

Primary phase: Elemental or Metallic Silver (Ag⁰)

Solubility: Highly water soluble

Mean TEM diameter: ˜5.8 nm (S.D.=2.8 nm)

Hydrodynamic diameter: ˜4.3 nm (average) (S.D.=1.3 nm)

Polydispersity Index (PDI): ^{˜}0.3

Shape: Spherical

Zeta (ζ) potential/Surface charge: +39.4 mV to +47.8 mV

Electrophoretic mobility (EPM): ^{˜}3.157 μm·cm/V·s

Specific conductivity: ˜122 μS-cm⁻¹

Localized plasmon resonance peak (λₘₐₓ): 416.5 nm (Absorbance=3.5 a.u.)

Surface ligand: amino (—NH₂) (primary), amide ([C═O]—N) (secondary)

Thickness of surface NH₂ layer around nanoparticle: 0.5-1.5 nm

Stability: over 3 years at room temperature

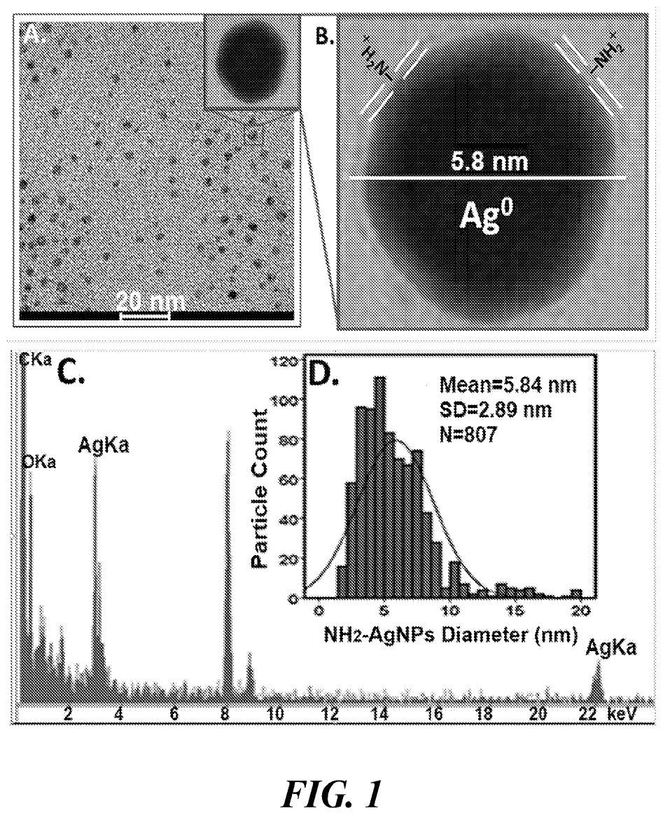

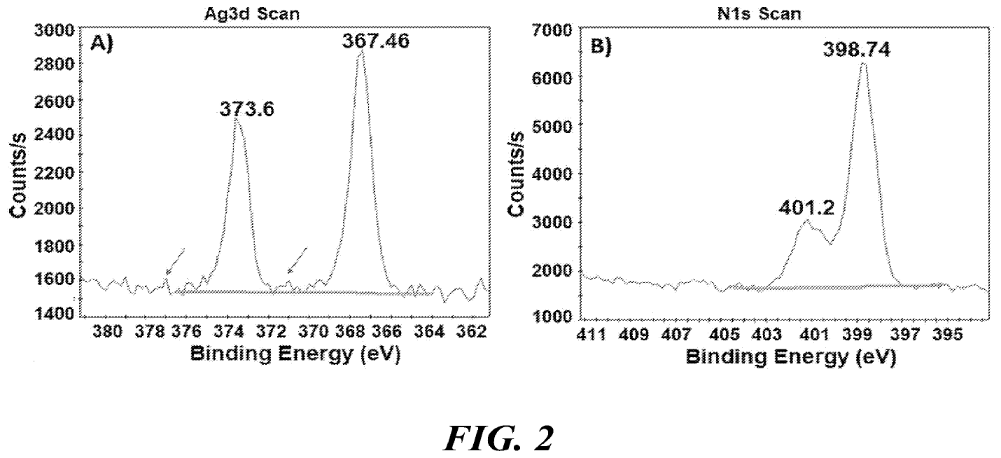

Transmission electron microscopy (TEM) images of NoPest-Ag5, which are 5 nm amino-surface functionalized silver nanoparticles (5 nm NH₂—AgNPs) are shown in FIG. 1, panels A and B. EDS performed on NoPest-Ag5, (FIG. 1, panel C) shows NoPest-Ag5 is primarily composed of elemental/metallic silver (Ag⁰). The particle morphology is generally spherical with a mean particle diameter of 5.8 nm±2.8 nm (N=807), as shown in FIG. 1, panel D. The capping layer (shown with paired white dashes, FIG. 1, panel B) on the surface of Ag⁰ core, as shown by XPS in FIG. 2, is primarily composed of amino (—NH₂) functional groups, with a trace amount of an ‘intermediate state’ of amide ([C═O]—N), bound to the metallic Ag⁰ surface. XPS high resolution scans of NoPest-Ag5 show: (panel A) typical asymmetric well-separated peaks of elemental/metallic silver (Ag⁰) with a primary Ag (3d) peak around 367.46 eV and loss features observed to the higher binding energy side of each spin-orbit component of Ag metal (arrows); and (panel B) a primary N (1s) peak of the amino (—NH₂) functional group at 398.74 eV, with a minor secondary peak at 401.2 eV, indicative of a trace level of an ‘intermediate state’ of amide ([C═O]—N) (ref. [32]) on the metallic Ag⁰ surface.

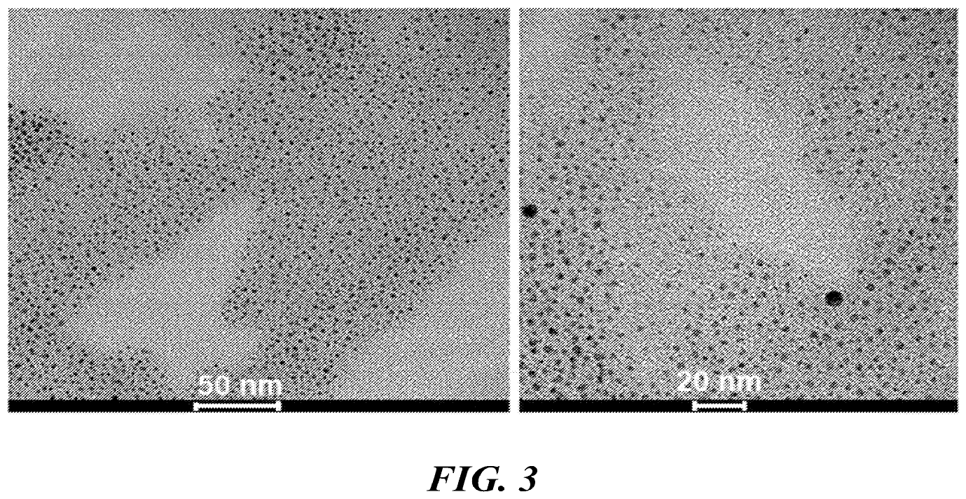

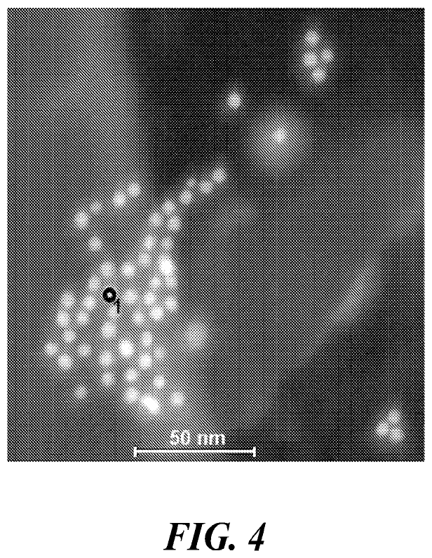

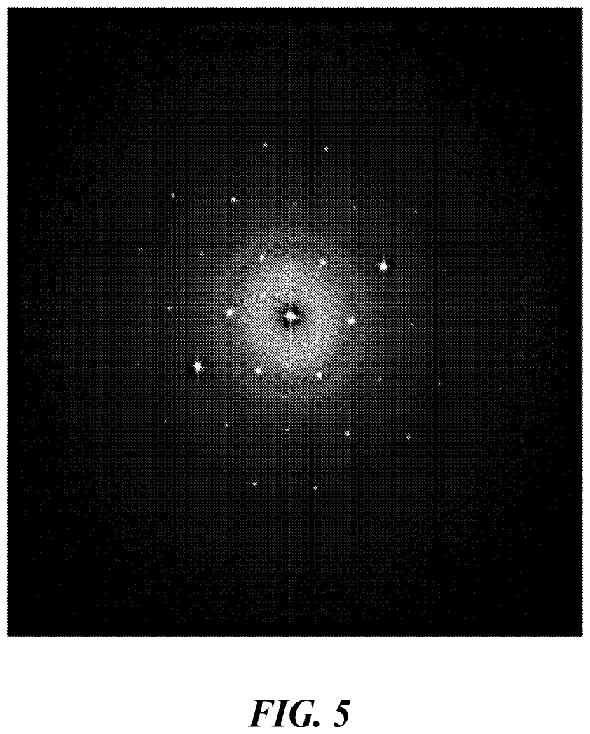

Additional TEM images of NoPest-Ag5 are shown in FIG. 3, and a scanning transmission electron microscopy (STEM) darkfield mode image of NoPest-Ag5 is shown in FIG. 4. An electron diffraction pattern obtained by FFT of the image area shown by the circle (1) in FIG. 4 is shown in FIG. 5. This electron diffraction pattern in FIG. 5 confirms that the NH₂—AgNPs are in a pure crystalline phase.

### Example 2

### Effectiveness: (1) NoPest-Ag5 for Vector Control

The present inventive concept has demonstrated significant inhibitory effects at a low dose of 0.5 mg/L (ppm; total silver on mass basis) against the eggs, larvae and pupae of Aedes aegypti mosquitos. Eggs exposed to 0.5 mg/L NoPest-Ag5 led to 100% egg death (N=30), with no metamorphosis and adult emergence. Upon exposure of 1^{st} instar larvae to 0.5 mg/L of NoPest-Ag5, development was significantly arrested with no pupal emergence by day-24, while control larvae had transformed into pupae by day-4. Upon exposure of 3^{rd} instar larvae to 0.5 mg/L of NoPest-Ag5, the larvae suffered 91.7% mortality by day-25. About 9% of 3^{rd} instar larvae that survived the 0.5 mg/L NoPest-Ag5 treatment molted into pupae; which, however, died (100%) upon emergence as immature adults, suggesting the role of NoPest-Ag5 as a potent insect growth regulator (IGR). We then compared the efficacy of NoPest-Ag5 against Novaluron, a potent IRG used for mosquito control, and found that NoPest-Ag5 performed equally or better than Novaluron against Ae. aegypti mosquitos at comparable concentrations.

### Example 3

### Evidence of Physical Damage in Aedes aegypti Eggs (Surface/Morphology)

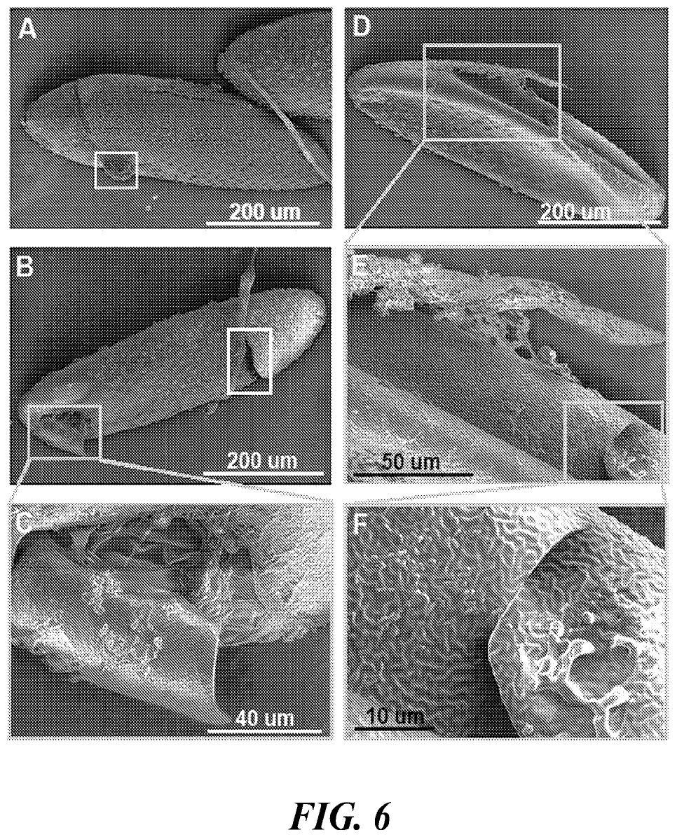

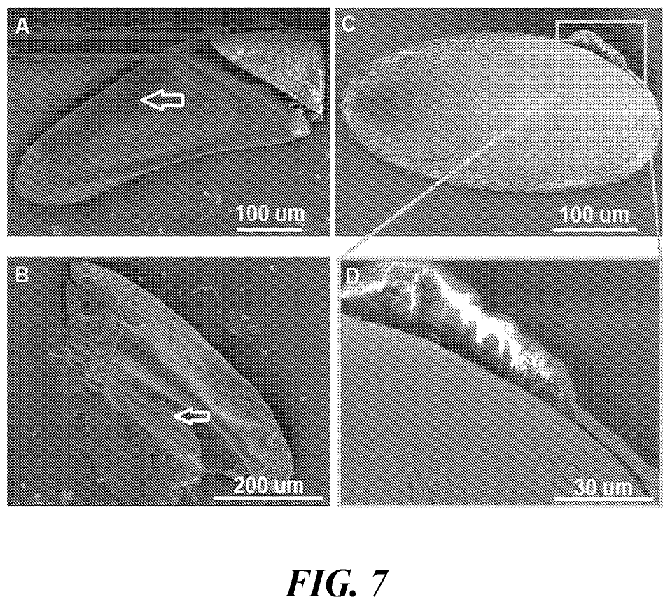

Scanning electron microscopy (SEM) revealed significant physical damage in the egg form and structure including egg rupture, deflated (squeezed-like) phenotype, sloughed off exochorion (egg surface ornamentation removed) and egg-oozing (content gushing out), leading to 100% egg death before hatching in Ae. Aegypti occurring upon treatment at 0.5 mg/L (ppm) NH₂—AgNPs (FIG. 6, panels A, B, and C) and 100 mg/L (ppm) NH₂—AgNPs (FIG. 7 panel B). In experiments where eggs were exposed to 0.5 mg/L NH₂—AgNPs, eggs (n=30) were incubated in the respective treatment suspensions at 28° C. with 16:8 h day:night photoperiod for 24 h before they were imaged using SEM. Physical damage of the egg architecture (FIG. 6, panel B, indicated by the rectangles, enlargement shown in FIG. 6, panel C) and egg content oozing (FIG. 6, panel A, shown with the white rectangle) upon NH₂—AgNPs treatment at 0.5 mg/L can explain the complete inhibition of egg hatching that we observed in Ae. aegypti mosquitos. In experiments where eggs were exposed to 0.05 mg/L NH₂—AgNPs (FIG. 7, panel A) and 100 mg/L NH₂—AgNPs (FIG. 7, panel B), eggs (n=30) were incubated in the respective treatment suspensions at 28° C. with 16:8 h day:night photoperiod for 24 h before they were imaged using SEM. Physical damage of the egg exochorion (egg surface ornamentation; FIG. 7, shown by the arrows in panels A and B) and egg-oozing upon NH₂—AgNPs treatment can explain complete inhibition in egg hatching that we observed in Ae. aegypti mosquitos.

### Example 4

### NoPest-Ag5 as an Antimicrobial

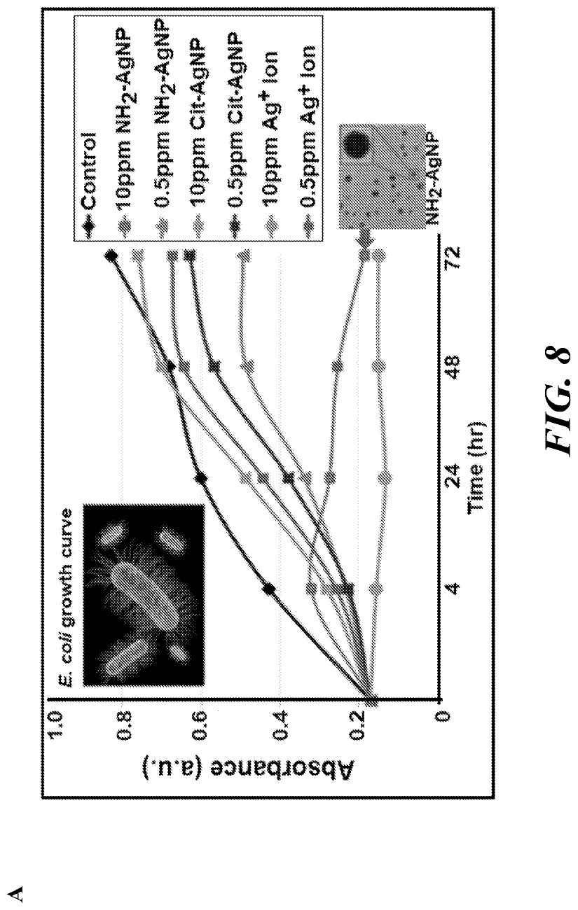

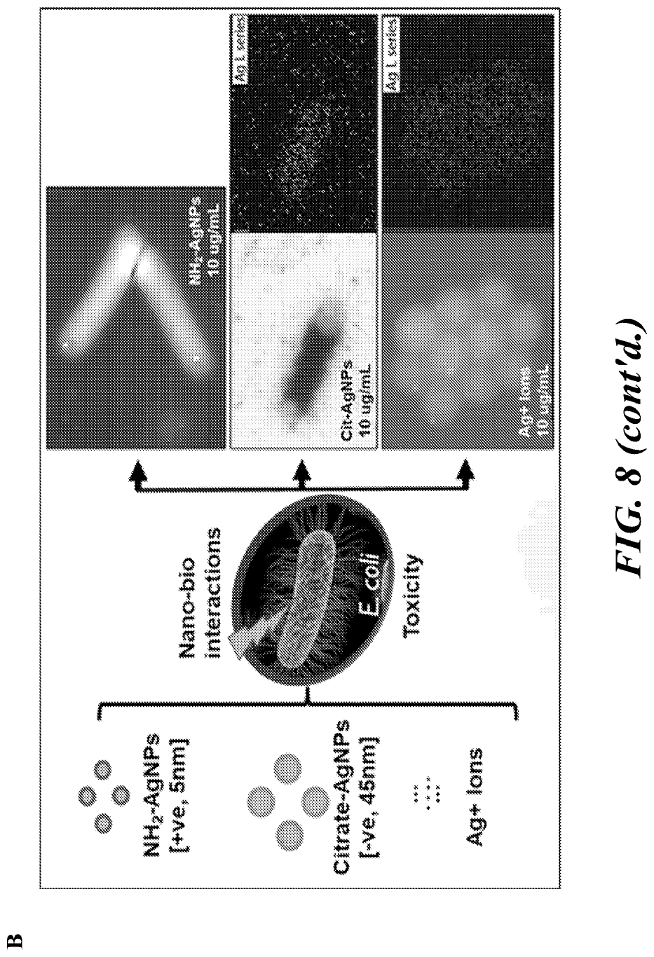

NoPest-Ag5 also demonstrated significant inhibitory effects at 10 mg/L (ppm) against gram-negative E. coli bacteria (E. coli DH5α and E. coli K12 strains), which consists of strains that are known to develop antibiotic resistance (AR), are difficult to treat human infections and/or lead to sepsis. The inhibition is likely due to surface-induced electrostatic interactions between positively charged NoPest-Ag5 (ζ potential=+41 mV) and negatively charged bacterial cell wall (ζ potential=−26.4 mV for E. coli K12; ζ potential=−11 mV to −14.8 mV for E. coli DH5α), leading to cell damage, loss of fimbriae and death; hence, is bactericidal in nature. It may be shown that NoPest-Ag5 can serve as a broad-spectrum antimicrobial agent against AR and multi-drug resistant (MDR) bacteria including other pathogenic microbes. FIG. 8, panel A shows the antimicrobial effects of high positively charged, around 5 nm diameter NH₂—AgNPs against gram negative Escherichia coli DH5α and K12 strains compared to dissolved Ag⁺ ions and negatively charged, 46 nm diameter carboxylate/citrate AgNPs (Cit-AgNPs). At 10 mg/L, NH₂—AgNPs significantly inhibited E. coli growth compared to Cit-AgNPs. Based on the nature of the growth curves, NH₂—AgNPs at 10 ppm showed bactericidal effects, while Ag⁺ ions at 10 ppm showed bacteriostatic effects. Exposure for 10 minutes to 10 mg/L NH₂—AgNPs leads to adherent fimbriae inhibition resulting from the surface interaction of the NH₂—AgNPs with E. coli DH5α (FIG. 8, panel B). By 72 h, no intact cells were present due to cell wall damage, in contrast to the effects observed for the surface interaction of Cit-AgNPs (intact cells with adherent fimbriae were observed and no apparent cell damage) and of Ag⁺ ions with E. coli DH5α (intact cells were observed, but with a shape change to a hexagonal honeycomb like phenotype lacking adherent fimbriae), at 10 mg/L (as total Ag).

### Example 5

### Safety Data

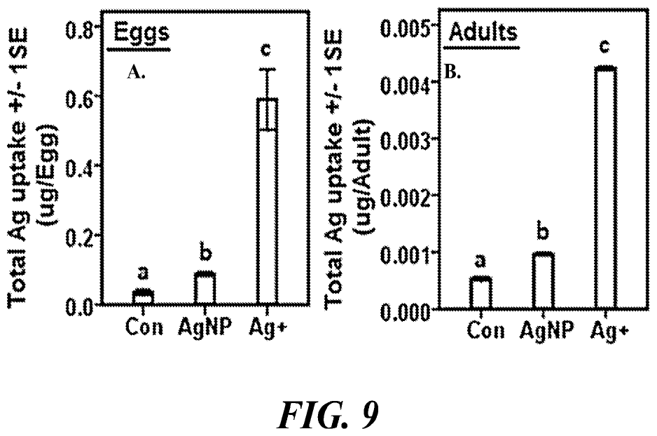

Total Ag body burden (biouptake) in eggs, and adults (that developed from larvae exposed at 3^{rd} instar stage) treated with 0.5 mg/L (ppm) NH₂—AgNPs or 0.5 mg/L Ag⁺ ions (positive control) (FIG. 9, panels A, B) were quantified using Inductively Couple Plasma Mass Spectrometer (ICP-MS). Our results showed that mosquito body burden of Ag when exposed to AgNPs was significantly lower (681% lower) compared to Ag⁺ ions treatment (positive control) at the same dose (FIG. 9, panel A). Further, adults had almost two-order of magnitude lower Ag body burden than eggs for both ‘nano’ and ionic Ag⁺ treatments (FIG. 9, panel B). Total Ag burden in eggs was 569% lower with NH₂—AgNPs compared to Ag⁺ ions treatments. With miniscule Ag burden from NH₂—AgNPs exposure in mosquitos—a prominent food source for many species of fish and birds—strongly suggests that the trophic transfer of Ag to higher trophic levels via mosquitos (as a prey) would be significantly low and demonstrates promise for NH₂—AgNPs to serve as a novel, sustainable mosquito vector control tool.

Generally, when AgNPs are released into the natural environment, particularly in soils and waters, their surface properties can change upon interactions with various compounds, ions, and/or ligands (i.e., humic acids, fluvic acids, cysteine, fertilizers, common minerals such as sodium, potassium, calcium, magnesium, etc.) readily available in such environments, likely promoting particle growth, aggregation and rendering them less toxic to the non-target receptor organisms (refs. [33-39]).

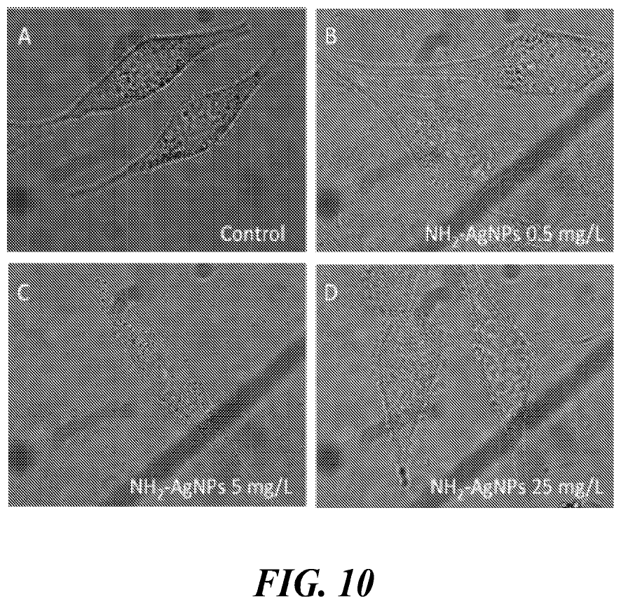

Effects of exposure of human HeLa cells are shown in FIG. 10. HeLa cells were exposed to 5 nm sized NH₂—AgNPs at 0, 1, 5 and 25 mg/L (ppm) doses, and various cellular responses were recorded, including morphology, early cell rounding, cytoplasmic inclusion bodies, nucleus rounding, vacuole formation, and number of cellular extensions observed using optical microscopy for over 12 hours. This examination found NH₂—AgNPs to be non-toxic to HeLa cells at all doses tested, indicating that human exposure to NH₂—AgNPs at concentrations 50 times greater than those used for mosquito control applications is non-toxic, indicating drifted particles will not pose a health risk.

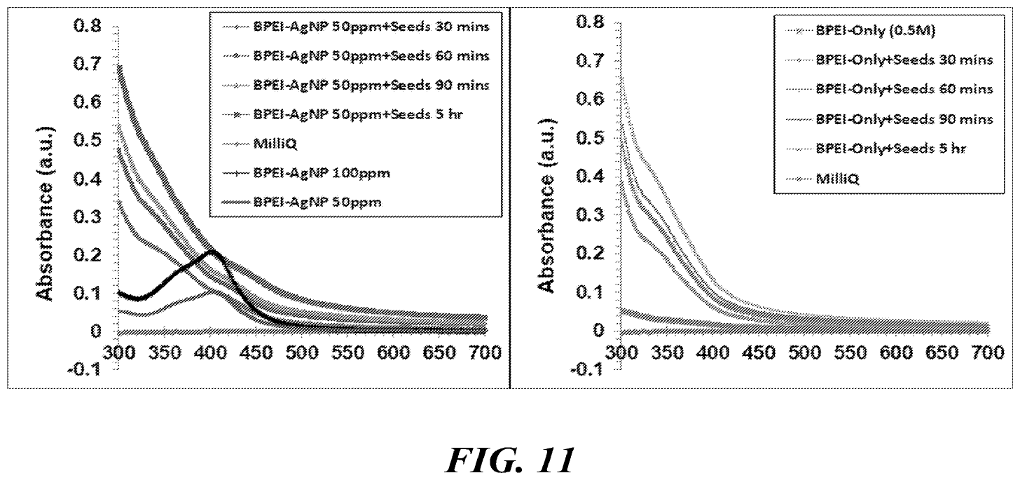

Interactions with soybean seed are shown in FIG. 11. Soybean seeds (Glycine max) were exposed to 5 nm sized NH₂—AgNPs at 50 mg/L (ppm) (100× higher than concentrations that were demonstrated to kill mosquitos), and UV-Vis absorbance spectra recorded of the solution over time (0, 30 min., 60 min., 90 min., and 5 h.) to understand potential interactions between the seed surface and the NH₂—AgNPs. The absorbance values determined from the spectra of BPEI only, the amine used to prepare the NH₂—AgNPs, showed little difference when compared to the absorbance values determined for seed exposed to the NH₂—AgNPs, consistent with little or no effect of the NH₂—AgNPs to soybean seeds.

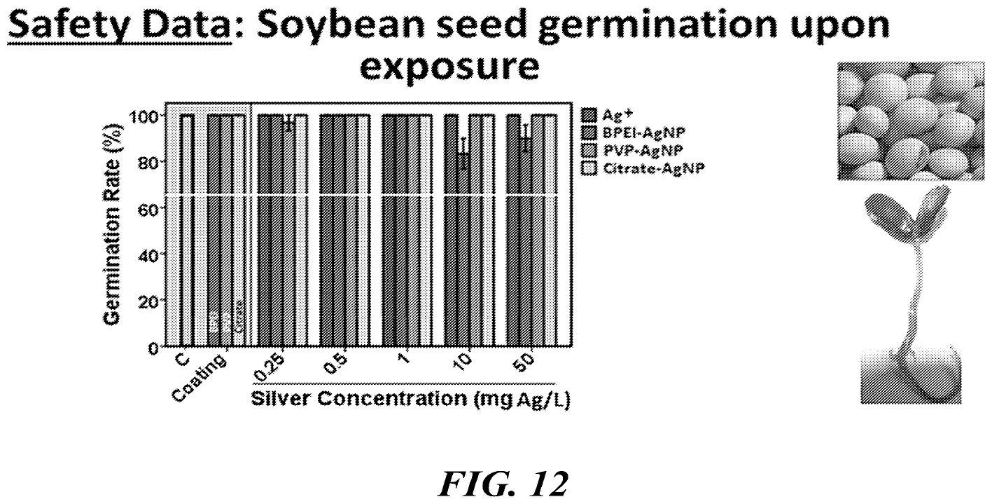

The effects on soybean seed germination upon exposure to the 5 nm NH₂—AgNPs are shown in FIG. 12. soybean seed were exposed to 5 nm-sized NH₂—AgNPs (BPEI-AgNP) and compared to two other types of silver nanoparticles (PVP—AgNP and citrate-AgNP) and Ag⁺ ions at various concentrations (0.25-50 mg/L or ppm), and seed germination recorded in Petri dishes with filter paper as a growth substrate (n=30 per treatment type) after 7 days in a growth chamber with a 16:8 h. photoperiod. The results showed that NH₂—AgNPs, including other types of NH₂—AgNPs and Ag⁺ ions tested, were non-toxic in germination and early development of soybean seedlings were not affected as the germination rates (%) were significantly above the US EPA OPPTS germination threshold of 65% (shown with the horizontal white line). This lack of toxicity mirrors the results from seed surface interactions with NH₂—AgNPs.

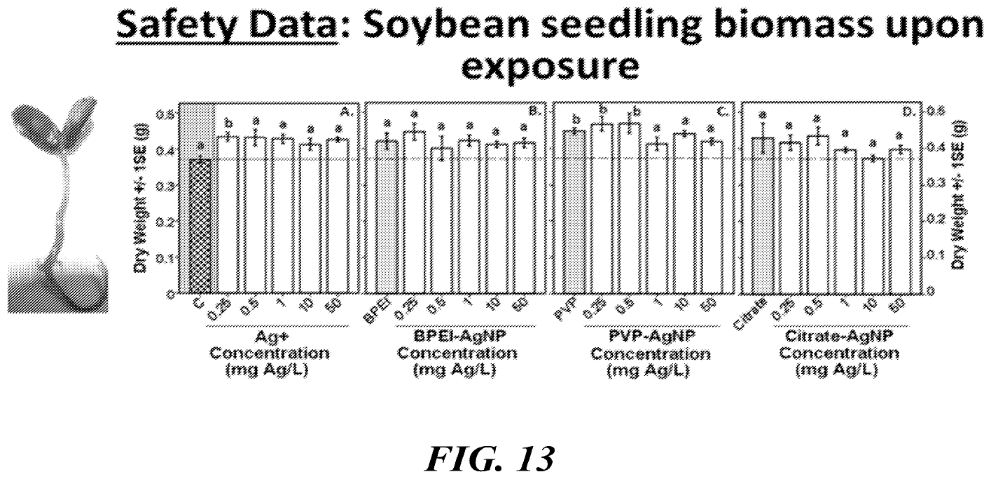

The effects on soybean seedling biomass upon exposure to NH₂—AgNPs are shown in FIG. 13. Soybean seeds were exposed to 5 nm NH₂—AgNPs and compared with PVP—AgNP, citrate-AgNP, and Ag⁺ ions at various concentrations (0.2-50 mg/L or ppm), and seedling biomass recorded at day-7. The results show that NH₂—AgNPs, including other types of AgNPs and Ag⁺ ions tested, actually promoted seedling biomass at all concentrations tested compared to the control (water only), and that NH₂—AgNPs are non-toxic to early growth and development of soybean crops.

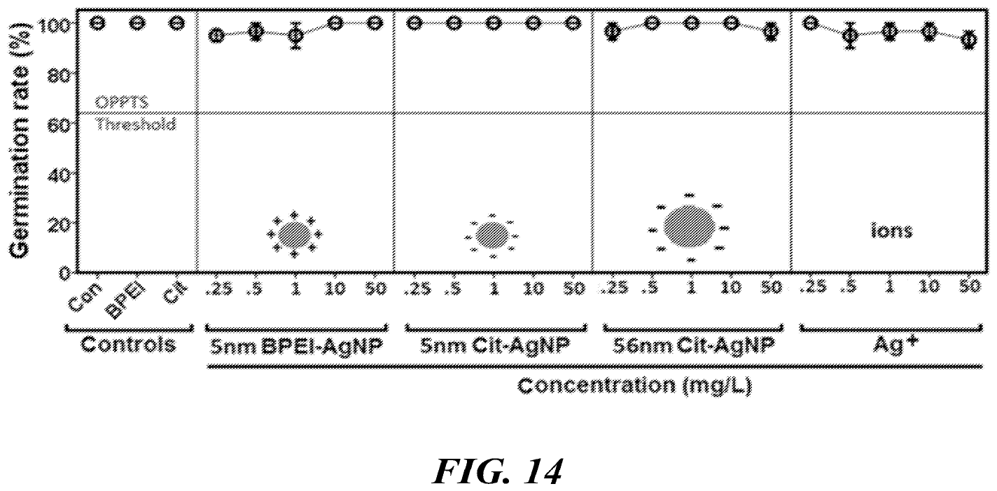

The effects on corn seed germination upon exposure to NH₂—AgNPs are shown in FIG. 14. Corn (Zea mays) seeds were exposed to 5 nm NH₂—AgNPs and compared with 5 nm and 56 nm cit-AgNPs, as well as Ag⁺ ions at various concentrations (0.25-50 mg/L or ppm), and seed germination recorded in Petri dishes with filter paper as a growth substrate (n=30 per treatment type) after 7 days in a growth chamber with a 16:8 h. photoperiod. The results showed that NH₂—AgNPs, including other types of NH₂—AgNPs and Ag⁺ ions tested, were non-toxic in germination and early development of corn seedlings were not affected as the germination rates (%) were significantly above the US EPA OPPTS germination threshold of 65% (shown with the horizontal white line). This lack of toxicity mirrors the results from seed surface interactions with NH₂—AgNPs.

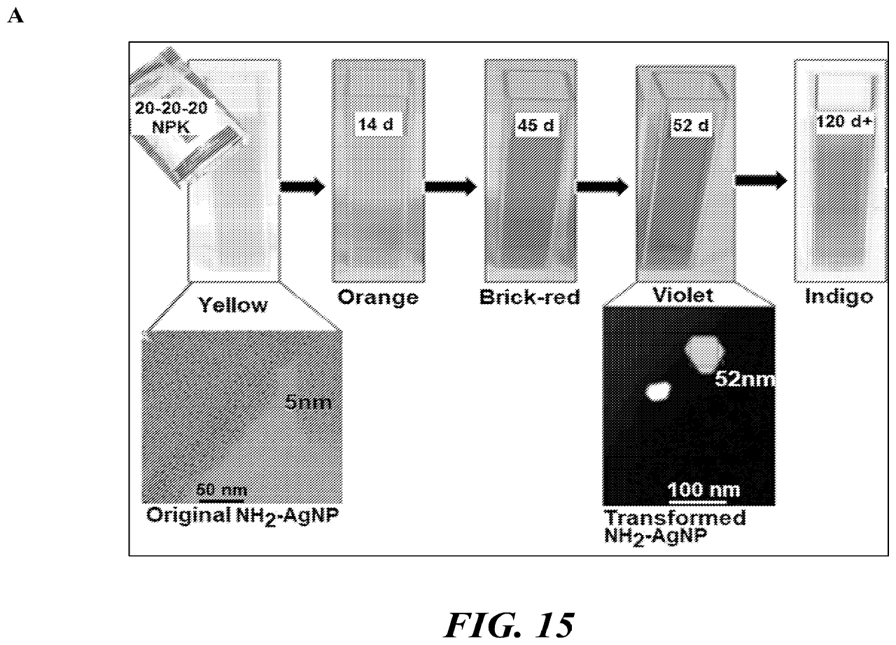

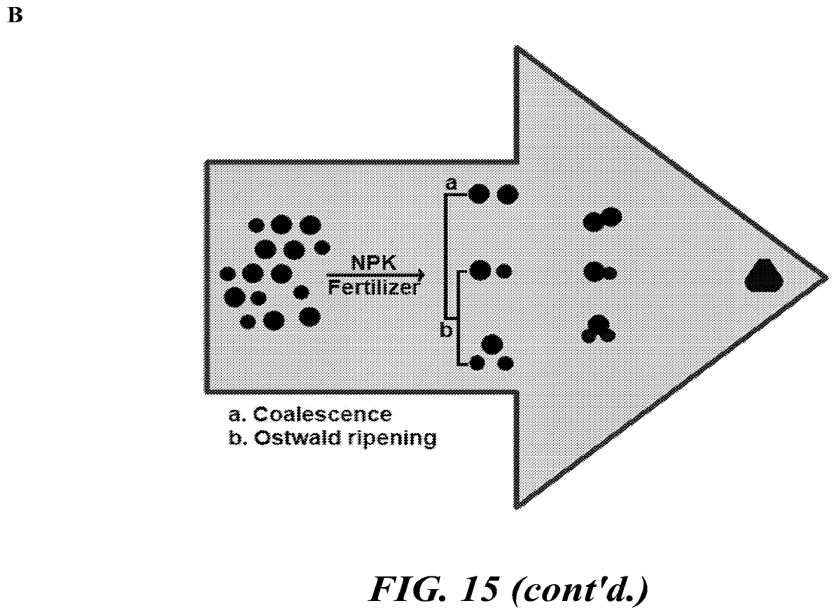

The fate of NH₂—AgNPs (10 mg/L or ppm) in water containing fertilizer is shown in FIG. 15. Visible color change in the NH₂—AgNPs was observed upon NPK (nitrogen 20%, phosphorus 20%, and potassium 20% each added at 10 ppm) fertilizer amendment as a result of particle size and shape/morphology transformation that occurred over time. TEM analysis showed that NH₂—AgNPs, in sizes ranging from ˜10-90 nm, were formed from the original 5 nm NH₂—AgNPs, with particles being transformed from their original spherical shape to hexagonal pyramidal (plate-like) nanocrystals by day-52. On average, the transformed particles were about 52 nm in the longest dimension (FIG. 15, panel A), and EDX analysis revealed that the particles were composed of metallic Ag, consistent with formation of these nanocrystals from the original 5 nm NH₂—AgNPs. The formation of larger pyramidal nanocrystals may be explained by coalescence and Ostwald's ripening (FIG. 15, panel B), and it is believed that the larger sized particles may be less toxic than the smaller size particles in the environment receiving runoff from fertilizer applied farms.

### Example 6

### Toxicity Data for NoPest-Ag5 (5 nm Amino-Silver Nanoparticles, NH₂—AgNPs) Against Aedes aegypti Mosquitos

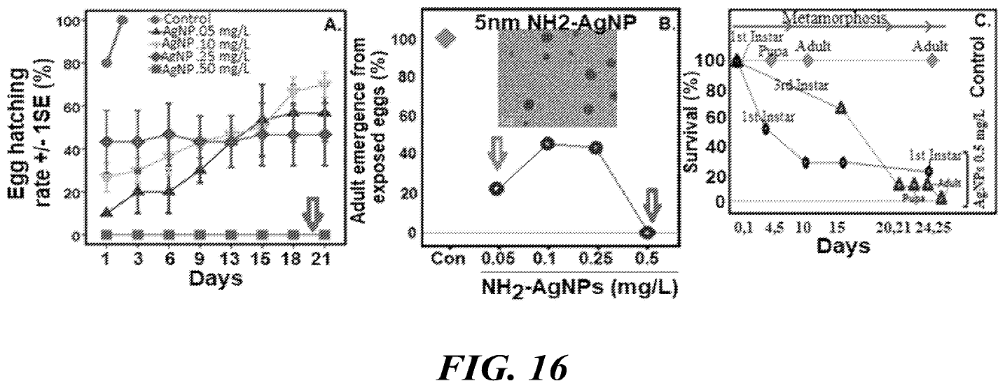

Toxicity of NH₂—AgNPs on Egg-hatch and Adult Emergence When Exposed as Egg. Eggs exposed to 0.5 mg/L (ppm) NH₂—AgNPs (˜5 nm diameter) led to 100% egg death (N=30) (FIG. 16, panel A), with no metamorphosis and adult emergence (FIG. 16, panel B). However, lower NH₂—AgNPs concentrations (below 0.5 mg/L) led to egg-hatch, which when allowed to grow in clean media (water+food; without NH₂-AgNPs) led to 23-46% adult emergence (FIG. 16, panel B). Hermetic or curvilinear dose-response curve was observed, with two middle doses (0.10 and 0.25 mg/L) showing higher adult emergence (%) compared to the lowest (0.05 mg/L) and highest (0.5 mg/L) treatment levels (FIG. 16, panel B).

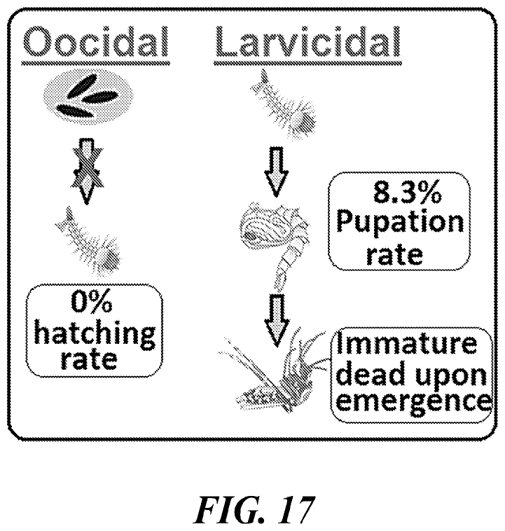

Toxicity of NH₂—AgNPs on Adult Emergence When Exposed as Larvae. Upon exposure of 1^{st} and 3^{rd} instar larvae to 0.5 mg/L (ppm) NH₂—AgNPs, we found 1^{st} instar's development to be significantly arrested at 0.5 mg/L NH₂—AgNPs treatment with no pupal emergence by day-24. At the same exposure level, 91.7% mortality of the 3^{rd} instar larvae occurred by day-25. About 9% of 3^{rd} instar larvae that survived the 0.5 mg/L NH₂—AgNPs treatment were able to molt into pupae; which, however, died (100%) upon emergence as immature adults (FIG. 16, panel C), suggesting potential role of the NH₂-AgNPs as a potent insect growth regulator (IGR). By day-15, only 30% of 1^{st} instar had survived the treatment (0.5 mg/L NH₂—AgNPs), whereas 62.5% of 3^{rd} instar larvae had survived at the same time. By day-24, only 20% of 1^{st} instar had survived, but did not molt into 2^{nd} instar. For 3^{rd} instars, pupation occurred by day-23 and pupae transformed into immature adults by day-25 but died upon emerging as immature adults. These results demonstrate higher sensitivity of mosquitoes to NH₂—AgNPs exposure during early development (1^{st} instar) compared to the later developmental stage (3^{rd} instar) in Ae. aegypti (FIG. 16, panel C). An overview of the oocidal and larvicidal activity of NH²—AgNPs on Ae. aegypti at 0.5 mg/L is shown in FIG. 17.

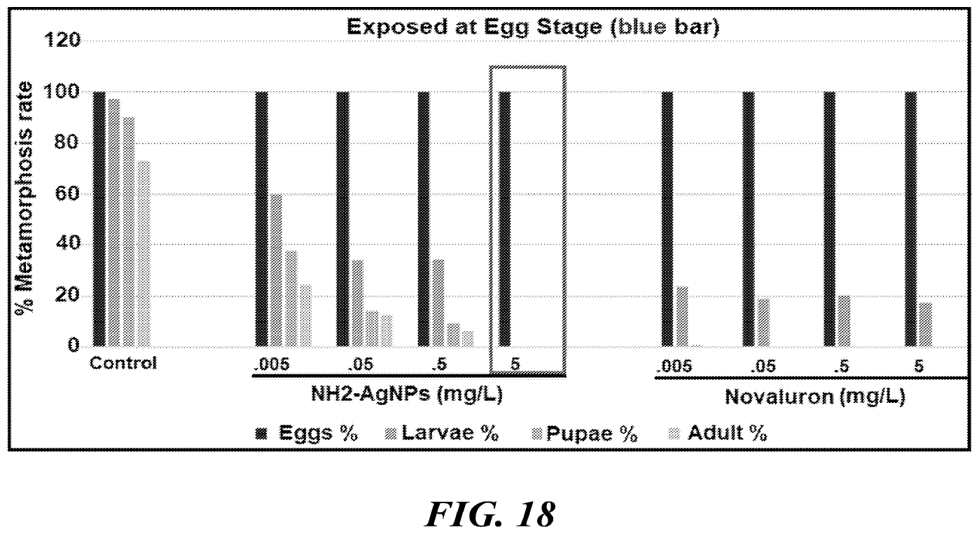

Comparative Toxicity of NH₂—AgNPs and Novaluron. Comparative toxicity of NH₂—AgNPs and Novaluron (Rimon® 10 EC) on eggs, larvae, pupae and adults on Aedes aegypti is shown in FIG. 18. At comparable concentrations (5 mg/L or ppm), NH₂-AgNPs performed significantly better than Novaluron, an Insect Growth Regulator (IRG), inhibiting various life stages in mosquitos.

### Example 7

### Synthesis Protocol for Making NH₂—AgNPs

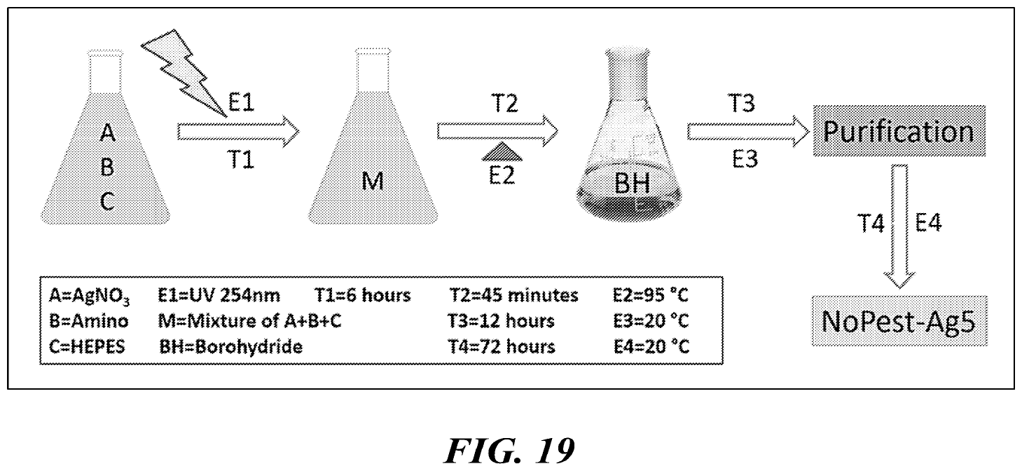

A representative one-pot synthesis protocol for making NoPest-Ag5 (5 nm NH₂—AgNPs) according to embodiments of the present inventive concept is outlined in FIG. 19. AgNO₃ and the amino (—NH₂) source, polyethyleneimine (PEI, MW: Mₙ=60,000, M_{w}=75,0000) is mixed in HEPES buffer at a molar ratio of 0.5:1.0:0.1 PEI:AgNO₃:HEPES, and the mixture exposed to UV light (254 nm) for 6 hours at room/ambient temperature (RT), followed by exposure to heat at 95° C. for 45 min., reduction with borohydride for 12 hours, during which time the mixture is allowed to cool to RT, and purification. Purification of NoPest-Ag5 can be achieved using a float-a-lyzer dialysis membrane with less than 10 kD (˜2 nm) diameter pore threshold, or via diafiltration using hollow fiber membranes of less than 10 kD (˜2 nm) diameter pore threshold for about 24 hours to about 72 hours at RT.

Exemplary data from X-ray photoelectron spectroscopy (XPS) analysis of NH₂—AgNPs produced showing peak binding energy (peak BE) and atomic weight % are listed in Table 1 These data confirm the presence of a near atomic sized Ag⁰ nanoparticle core, and proportions (atomic weight %) of surface functional groups/ligands including C, N, and O(—NH₂ and amide), differing significantly from previously prepared Ag nanoparticles or prior art.

TABLE 1
Peak ID (name), binding energy (BE) and
atomic weight % (At. %) obtained
from XPS analysis of NoPest-Ag5

| Name | Peak BE | At. % |
|---|---|---|
| Ag 3d | 367.46 | 0.42 |
| C 1s | 284.76 | 68.49 |
| N 1s | 398.74 | 11.79 |
| O 1s | 531.25 | 15.46 |

### Example 8

### Multiple Derivatives

Multiple derivatives, likely of higher potency, of the nanotechnology-based technology will be developed. The derivatives will contain one or more of the following surface ligands decorated onto the parent compound NoPest-Ag5 (NH₂—AgNPs), described herein and are listed in Table 2:

TABLE 2
Derivatives of NoPest-Ag5 with added surface ligands

| | Parent | Added | New |
|---|---|---|---|
| S.N. | Compound | Surface Ligand(s) | Derivatives |
| 1 | NoPest-Ag5 | | NoPest-Ag5 |
| 2 | NoPest-Ag5 | Oxalylchloride | NoPest-Ag5- |
| | | (OC) | OC |
| | | [ClCOCOCl] | |
| 3 | NoPest-Ag5 | Dichloroacetate | NoPest-Ag5- |
| | | (DCA) | DCA |
| | | [CHCl₂COO⁻] | |
| 4 | NoPest-Ag5 | Dibromoacetate | NoPest-Ag5- |
| | | (DBA) | DBA |
| | | [Br₂CHCOO⁻] | |
| 5 | NoPest-Ag5 | Difluorobenzamide | NoPest-Ag5- |
| | | (DFB) | DFB |
| | | [F₂C₆H₃C(O)NH₂] | |
| 6 | NoPest-Ag5 | Iodoacetate (IA) | NoPest-Ag5-IA |
| | | [C₂H₂IOO⁻] | |
| 7 | NoPest-Ag5 | DCA + DBA | NoPest-Ag5- |
| | | | DCA/DBA |
| 8 | NoPest-Ag5 | DCA + IA | NoPest-Ag5- |
| | | | DCA/IA |
| 9 | NoPest-Ag5 | DBA + IA | NoPest-Ag5- |
| | | | DBA/IA |
| 10 | NoPest-Ag5 | DCA + DBA + IA | NoPest-Ag5- |
| | | | DCA/DBA/IA |

### Example 9

### Aquatic Toxicity

1. Pseudokirchneriella subcapitata Toxicity

1.a. Cell growth: Green alga (P. subcapitata; also called Selenastrum capricornutum or Raphidocelis subcapitata) were cultured for 28 days, and both the acute (7 days) and chronic (28 days) toxicities were tested for NoPest-Ag5 and compared with its ionic counterpart (Ag⁺ ions), including Cadmium (Cd²⁺) ions (EPA positive control), and a neonicotinoid pesticide Imidacloprid. Five different comparable concentrations were tested for each test chemical. Experiments were repeated twice for NoPest-Ag5, Ag+ ions and control groups, and data were combined. Algae were cultured in an Erlenmeyer flask with 100 mL growth media using a16:8 h day:night cycle at 25±2° C. under the LED lighting of 4830 lux. Microscopic analysis coupled with hemocytometer was used to measure cell growth, and total chlorophyll (chlorophyll [a+b]) was used to measure primary productivity, in algae.

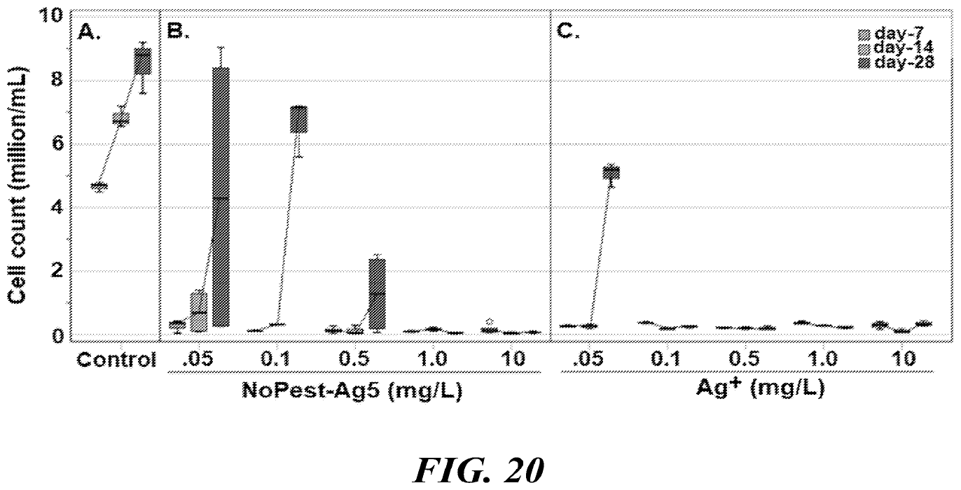

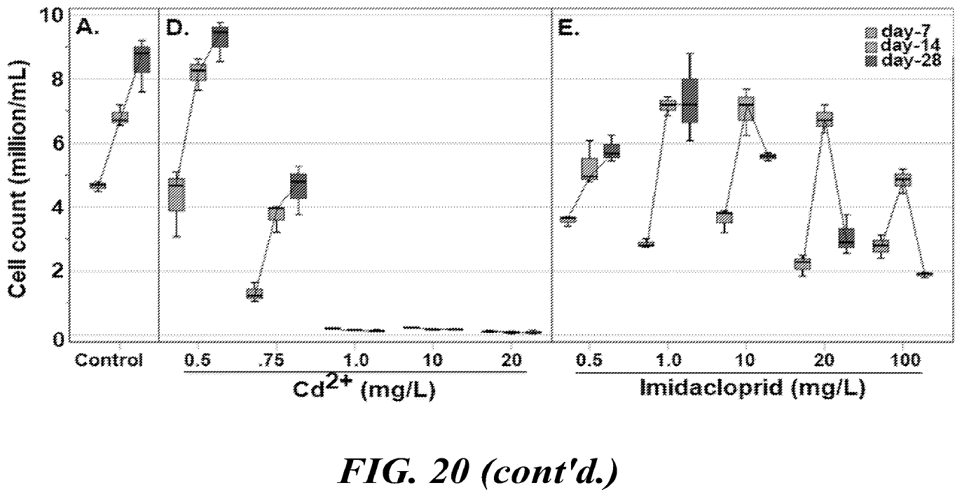

Overall, microscopic analysis of the cell count showed that exposure to NoPest-Ag5 was relatively less inhibitory to algae than Ag⁺ ions at comparable concentrations up to 0.5 mg/L (ppm). At or above 1 mg/L, both compounds inhibited algal growth compared to the control group (FIG. 20, panels A-C).

Cd²⁺ ions appeared stimulatory at the low concentration of 0.5 mg/L (ppm) compared to the control group, but the toxicity of Cd²⁺ ions increased at or above 0.75 mg/L (FIG. 20, panels A,D). Based on cell count, Imidacloprid was generally non-toxic, except at a high concentration of 100 mg/L (FIG. 20, panels A, E). Although cell growth increased until day-14 for Imidacloprid, by day-28 cell growth showed a concentration-dependent inhibition above 1 mg/L (FIG. 20, panel E).

Comparative analyses of all four test compounds showed that Imidacloprid was the least toxic and Ag⁺ ions were the most toxic to algae (FIG. 20).

1.b. Chlorophyll analysis: Chlorophylls (a and b) were extracted using 95% ethanol method, measured using UV-Vis spectrophotometer (Hach DR6000), and reported as total chlorophyll (a+b).

Consistent with the cell count results (FIG. 20), total chlorophyll (a+b) analysis of algae showed that exposure to NoPest-Ag5 was relatively less inhibitory to primary production in algae compared to Ag⁺ ions at comparable concentrations up to 0.1 mg/L (ppm) (FIG. 2, panels B, C). At 0.5 and 1 mg/L, both NoPest-Ag5 and Ag⁺ ions demonstrated similar inhibition in chlorophylls synthesis (FIG. 2, panels B, C). At 10 mg/L, Ag⁺ ions seemed to be less toxic compared to NoPest-Ag5, but this could also be attributed to higher absorbance of light by Ag⁺ ions at 10 mg/L and may not truly reflect increased chlorophyll content given the low cell count results as shown in FIG. 20, panel C.

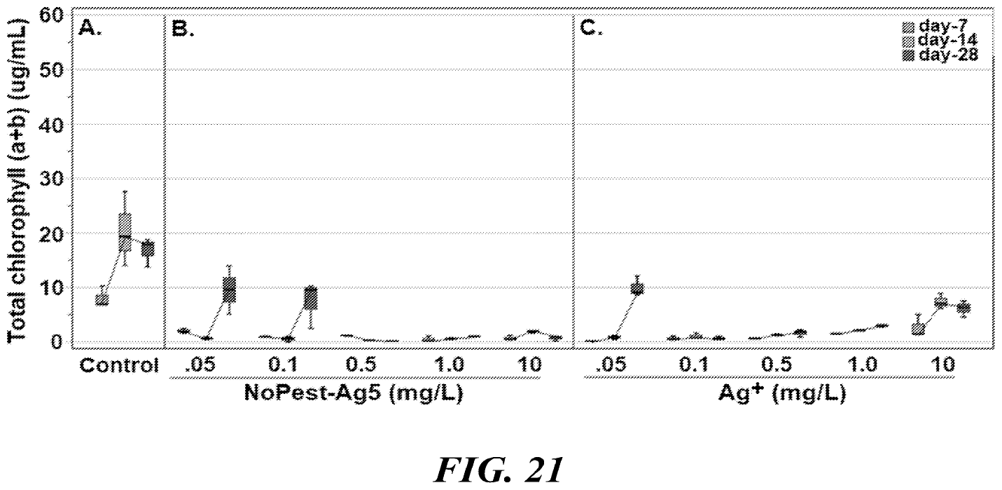

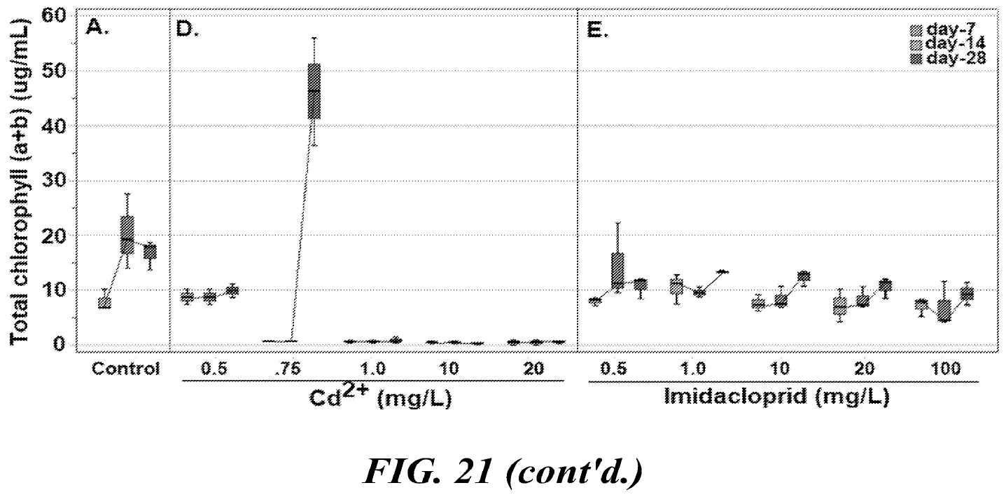

Cd²⁺ ions inhibited chlorophyll synthesis at or above 1 mg/L (ppm) compared to the control group, but at lower concentrations (0.05-0.75 mg/L) chlorophyll synthesis did occur (FIG. 21, panel D).

Consistent with the cell count results (FIG. 20), Imidacloprid was generally non-toxic with similar chlorophyll synthesis at all the concentrations tested, but the overall chlorophyll levels remained equivalent to day-7 results of the control group (FIG. 21, panel E).

Comparative analyses of all four test compounds showed that Imidacloprid was the least toxic, and Ag⁺ ions, NoPest-Ag5 and Cd²⁺ ions showed similar inhibition of chlorophyll synthesis (FIG. 21).

2. Daphnia magna Toxicity

Following the USEPA OPPTS 850.1300 protocol, we tested chronic toxicity of NoPest-Ag5 in Daphnia magna using 21-day reproduction as an endpoint. This mirrors OECD 202, Daphnia sp. Reproduction Test. Acute immobilization (48-hour survival) test was also performed concurrently to determine potential acute toxicity of NoPest-Ag5 in D. magna. Results were compared with positive controls: dissolved Ag⁺ ions and Imidacloprid. Daphnia were cultured in a beaker (500 mL) using 16:8 h day:night cycle at 20±2° C. under the diffused cool LED lighting.

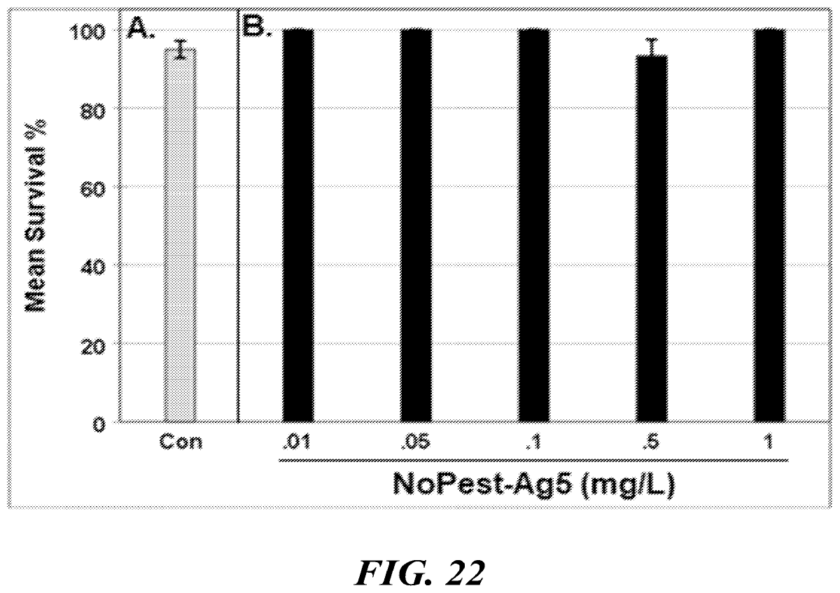

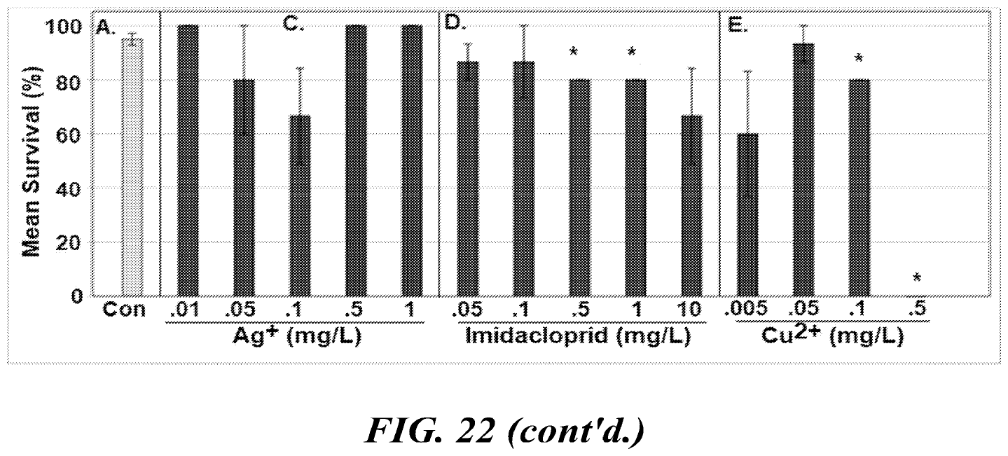

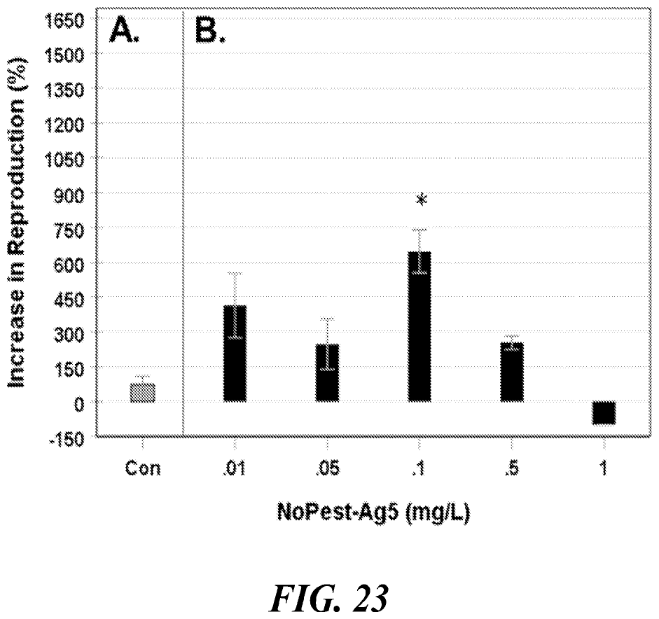

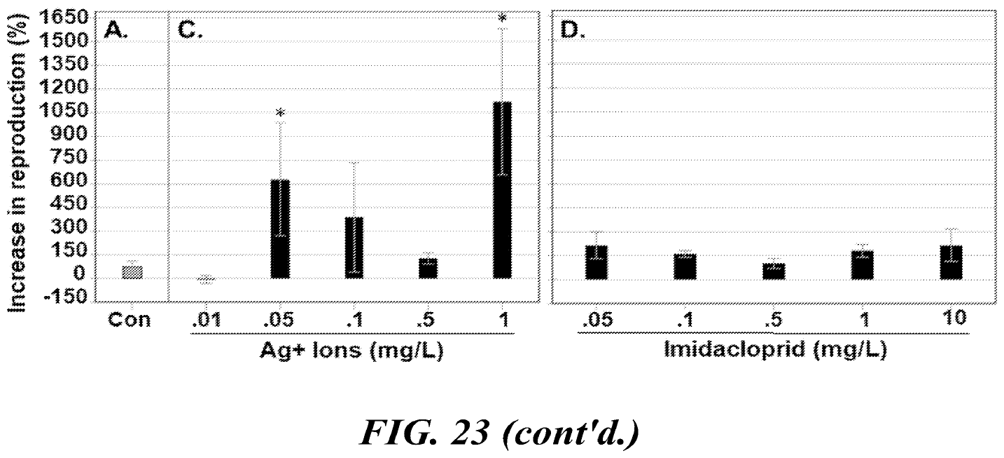

Acute 48-hour Survival Test: Results of the acute 48-hour survival test are presented in FIG. 22. Results showed that NoPest-Ag5 was nontoxic (mean survival: 93.3-100%) to D. magna at all concentrations tested (p>0.05) (FIG. 22, panel B). Dissolved Ag⁺ ions were also found to be not significantly toxic (mean survival: 66.6-100%) at all concentrations tested compared to the control group (p>0.05) (FIG. 22, panel C). Imidacloprid was found to be more toxic (mean survival: 66.6-86.6%) than NoPest-Ag-5 and Ag⁺ ions (FIG. 22, panel D); however, at 0.5 and 1 mg/L (ppm) Imidacloprid was significantly less toxic than 0.5 mg/L Cu²⁺ ions (p<0.0001). Overall, at 0.5 mg/L Cu²⁺ ions were significantly more toxic (mean survival: 0%) than all other compounds tested at comparable concentration (FIG. 22).

Chronic 21-day Reproduction Test: Results of the chronic 21-day reproduction test in D. magna are presented in FIG. 4. Results showed that NoPest-Ag5 was stimulatory (mean increase in reproduction in the range: 246.6-646.6%) up to 0.5 mg/L (ppm) concentrations (FIG. 4, panel B). However, at 1 mg/L of NoPest-Ag5 there was 100% death and thus no reproduction occurred (FIG. 4, panel B). Considering the natural environment where dilution occurs with precipitation (e.g., rain, snow melt), it can be concluded that NoPest-Ag5 application would be safer/non-toxic to reproduction in D. magna. Dissolved Ag⁺ ions were also found to be stimulatory (mean increase in reproduction in the range: 126.6-1120%), except at the lowest concentration of 0.01 mg/L that inhibited reproduction (mean decrease in reproduction: 6.6%) (FIG. 4, panel C). Imidacloprid group had reproduction not significantly different from control (p>0.1) (FIG. 4, panel D).

### Example 10

### Pollinator Toxicity

### 3. Honeybee Toxicity

Pollinators, especially honeybees, are susceptible to certain insecticides. Understanding the susceptibility of honeybees will determine the test substance's safe use in the environment as well as when the product should be used in relation to honeybee activity. Acute oral and contact (dermal) toxicity tests were conducted with the test substance, NoPest-Ag5, using the honeybee, Apis mellifera L., to determine if field application of NoPest-Ag5 for mosquito control has any effect on the pollinators such as honeybees.

Honeybee 48-hour Oral Exposure Test: Oral exposure followed OECD Test 213 method. Young adult worker honeybees were exposed to six doses of NoPest-Ag5 administered orally in 50% (w/v) sucrose solution. The test included nominal test item doses ranging from 1 to 400 ng a.i./bee (ppt a.i./bee) and a concurrent negative control group. Additional groups of bees from the same source were dosed with imidacloprid, at 0.0013, 0.0032 and 0.008 μg a.i./bee (ppb a.i./bee) as a positive control substance, also conducted concurrently. Three replicate test chambers were maintained in each control and treatment group, with 10 bees in each test chamber. Observations of mortality and other signs of toxicity were made for approximately 48 hours after dosing. Cumulative mortality observed in the test groups was used to determine the LD₅₀ (lethal dose that kills 50% of the test populations).

The results showed that NoPest-Ag5 was determined to be nontoxic (97%-100% survival) to young adult honeybees at all doses tested (0.05, 0.25, 0.5, 1, 10, 20 mg/L) in a 48-hr oral exposure test (Table 3). Therefore, the 48-hour oral LD₅₀ for NoPest-Ag5 is deemed to be greater than 400 ng a.i./bee (20 mg a.i./L), the highest level tested. This is 40 times greater than the concentration that kills Ae. Aegypti mosquitos. All surviving bees appeared normal at test termination for NoPest-Ag5 group.

TABLE 3
48-hour mortality of honeybees (Apis mellifera) following
oral exposure to NoPest-Ag5.

| | | | Consumption after 6 | | | 48-hour | |
|---|---|---|---|---|---|---|---|
| | | | hours: | | | Mortality | |
| | | | Provided | Consumed | | | Mean |
| Treatment Group | | Rep. | (μL) | (μL) | | (%) | (%) |
| | | | | | Mean | | |
| Negative | | A | 200 | 200 | 190 | 0 | 0 |
| Control | | B | 200 | 200 | | 0 | |
| | | C | 200 | 170 | | 0 | |
| NoPest- | 1 ng a.i./bee | A | 200 | 200 | 200 | 0 | 0 |
| Ag5 | [0.05 mg a.i./L] | B | 200 | 200 | | 0 | |
| | | C | 200 | 200 | | 0 | |
| | 5 ng a.i./bee | A | 200 | 200 | 200 | 0 | 0 |
| | [0.25 mg a.i./L] | B | 200 | 200 | | 0 | |
| | | C | 200 | 200 | | 0 | |
| | 10 ng a.i./bee | A | 200 | 200 | 200 | 0 | 0 |
| | [0.5 mg a.i./L] | B | 200 | 200 | | 0 | |
| | | C | 200 | 200 | | 0 | |
| | 20 ng a.i./bee | A | 200 | 195 | 190 | 0 | 0 |
| | [1 mg a.i./L] | B | 200 | 200 | | 0 | |
| | | C | 200 | 175 | | 0 | |
| | 200 ng a.i./bee | A | 200 | 200 | 200 | 10 | 3 |
| | [10 mg a.i./L] | B | 200 | 200 | | 0 | |
| | | C | 200 | 200 | | 0 | |
| | 400 ng a.i./bee | A | 200 | 150 | 183 | 0 | 3 |
| | [20 mg a.i./L] | B | 200 | 200 | | 0 | |
| | | C | 200 | 200 | | 10 | |
| Positive | 0.0013 μg a.i./bee | A | 200 | 200 | 198 | 0 | 0 |
| Control¹ | [0.0065 mg a.i./L] | B | 200 | 195 | | 0 | |
| | | C | 200 | 200 | | 0 | |
| | 0.0032 μg a.i./bee | A | 200 | 140 | 163 | 0 | 3 |
| | [0.016 mg a.i./L] | B | 200 | 150 | | 10 | |
| | | C | 200 | 200 | | 0 | |
| | 0.008 μg a.i./bee | A | 200 | 85 | 88 | 0 | 7 |
| | [0.04 mg a.i./L] | B | 200 | 110 | | 20 | |
| | | C | 200 | 70 | | 0 | |

¹Positive Control material was Imidacloprid.

There was an apparent treatment-related reduction in diet consumption among the Imidacloprid (positive control) groups, where mean consumption ranged from 88 to 198 μL per replicate. Imidacloprid (positive control) was deemed to be nontoxic to honeybees with average survival ranging from 93%-97% (Table 3). In this case, the lack of mortality in the positive control group was attributed to dose avoidance and not tolerance of the honeybees used in the test. All surviving bees appeared normal at test termination.

Honeybee 48-hour Contact (Dermal) Exposure Test Contact exposure followed OECD Test 214 method. Young adult worker honeybees were exposed to six test doses ranging from 0.1 to 40 ng a.i./bee administered topically to the dorsal side of the thorax of each bee in a 2 μL droplet of water containing 1% Tween 80 surfactant. A negative control group and a surfactant control group were maintained concurrently. Additional groups of bees from the same source were nominally dosed with imidacloprid, at 0.032, 0.08 and 0.2 μg a.i./bee as a positive control substance. The positive control test was conducted concurrently with the definitive test and the bees were administered topically to the dorsal side of the thorax of each bee in a 2.0 μL droplet with water containing 1 Tween 80 surfactant. Three replicate test chambers were maintained in each control and treatment group, with 10 bees in each test chamber. Observations of mortality and other signs of toxicity were made for approximately 48 hours after dosing. Cumulative mortality observed in the test groups was used to determine the LD₅₀.

Results of the contact exposure test are summarized in Table 4. The results showed that NoPest-Ag5 was nontoxic (100% survival; n=30 bees per test concentration) to young adult honeybees at all doses tested (0.05, 0.25, 0.5, 1, 10, 20 mg/L) in a 48-hr contact exposure test (Table 4). Therefore, the 48-hour contact LD₅₀ for NoPest-Ag5 was deemed to be greater than 40 ng a.i./bee (20 mg a.i./L), the highest level tested. This is 40 times greater than the concentration that kills Ae. Aegypti mosquitos. All surviving bees appeared normal at test termination for NoPest-Ag5 group.

Imidacloprid (positive control) was found to be significantly toxic to honeybees with average survival ranging from 10%-77% (Table 4, n=30 bees per test concentration), and an LD₅₀ of 0.11 μg a.i./bee. Several surviving bees appeared lethargic (24 lethargic out of 54 surviving bees=46.3%) in the Imidacloprid group.

TABLE 4
48-hour mortality of honeybees (Apis mellifera)
following contact (dermal) exposure to NoPest-Ag5.

| | | | 48-hour Mortality | |
|---|---|---|---|---|
| Treatment Group | | Rep. | (%) | Mean (%) |
| Negative Control | | A | 0 | 0 |
| | | B | 0 | |
| | | C | 0 | |
| Surfactant Control | | A | 0 | 0 |
| (water + 1% Tween 80) | | B | 0 | |
| | | C | 0 | |
| NoPest-Ag5 | 0.1 ng a.i./bee | A | 0 | 0 |
| | [0.05 mg a.i./L] | B | 0 | |
| | | C | 0 | |
| | 0.5 ng a.i./bee | A | 0 | 0 |
| | [0.25 mg a.i./L] | B | 0 | |
| | | C | 0 | |
| | 1 ng a.i./bee | A | 0 | 0 |
| | [0.5 mg a.i./L] | B | 0 | |
| | | C | 0 | |
| | 2 ng a.i./bee | A | 0 | 0 |
| | [1 mg a.i./L] | B | 0 | |
| | | C | 0 | |
| | 20 ng a.i./bee | A | 0 | 0 |
| | [10 mg a.i./L] | B | 0 | |
| | | C | 0 | |
| | 40 ng a.i./bee | A | 0 | 0 |
| | [20 mg a.i./L] | B | 0 | |
| | | C | 0 | |
| Positive | 0.008 μg a.i./bee | A | 0 | 10 |
| Control¹ | [4 mg a.i./L] | B | 20 | |
| | | C | 10 | |
| | 0.032 μg a.i./bee | A | 40 | 33 |
| | [16 mg a.i./L] | B | 10 | |
| | | C | 50 | |
| | 0.2 μg a.i./bee | A | 70 | 77 |
| | [100 mg a.i./L] | B | 100 | |
| | | C | 60 | |

¹Positive Control material was Imidacloprid.

### REFERENCES CITED

1. Verified Market Research; www.verifiedmarketresearch.com.
2. De A, Bose R, Kumar A, Mozumdar S. Targeted Delivery of Pesticides Using Biodegradable Polymeric Nanoparticles. SpringerBriefs in Molecular Science 2014. DOI: 10.1007/978-81-322-1689-6_2.
3. Roser M, Ritchie H. Fertilizer and Pesticides. Available at: ourworldindata.org/fertilizer-and-pesticides
4. World Health Organization (WHO), 2019. Dengue Control. Available at: www.who.int/denguecontrol/disease/en/.
5. CDC, 2019. Malaria. Available at: www.cdc.gov/malaria/about/disease.html
6. Bell E M, Hertz-Picciotto I, Beaumont J J. A Case-Control Study of Pesticides and Fetal Death Due to Congenital Anomalies. Epidemiology 2001:12(2), 148-156.
7 Arcury T A, Quandt S A. Pesticides at Work and at Home: Exposure of Migrant Farmworkers. The Lancet 2003:362(9400), 2021.
8. Rappazzo K M, Warren J L, Meyer R E, Herring A H, Sanders A P, et al. Maternal Residential Exposure to Agricultural Pesticides and Birth Defects in a 2003 to 2005 North Carolina Birth Cohort. Birth Defects Research Part A: Clinical and Molecular Teratology 2016:106(4), 240-249.
9. Schreinemachers D M. Birth Malformations and Other Adverse Perinatal Outcomes in Four U.S. Wheat-Producing States. Environmental Health Perspectives 2003:111(9), 1259-1264.
10. Engel S M, Bradman A, Wolff M S, Rauh V A, Harley K G, Yang J H, et al. Prenatal Organophosphorus Pesticide Exposure and Child Neurodevelopment at 24 Months: An Analysis of Four Birth Cohorts. Environmental Health Perspectives 2015:124(6), 822-30.
11. Bittman M. A Watchful Eye on Farm Families' Health. The New York Times, 24 Sep. 2015. Available at: www.nytimes.com/2015/09/24/opinion/mark-bittman-a-watchful-eye-on-farm-families-health.html.
12. CHAMACOS Study. Environmental Exposures|CERCH, University of California, Berkeley. Available at: www.cerch.berkeley.edu/research-programs/chamacos-study.
13. Ye M, Beach J, Martin J W, Senthilselvan A. Occupational Pesticide Exposures and Respiratory Health. International Journal of Environmental Research and Public Health 2013:10(12), 6442-6471.
14. Hu R, Huang X, Huang J, Li Y, Zhang C, Yin Y, et al. Long- and Short-Term Health Effects of Pesticide Exposure: A Cohort Study from China. Plos One 2015:10(6), e0128766. doi:10.1371/journal.pone.0128766.
15. Raanan R, Balmes J R, Harley K G, Gunier R B, Magzamen S, et al. Decreased Lung Function in 7-Year-Old Children with Early-Life Organophosphate Exposure. Thorax 2015:71(2), 148-153. doi:10.1136/thoraxjnl-2014-206622.
16. Aschengrau A, Ozonoff D, Coogan P, Vezina R, Heeren T, et al. Cancer risk and residential proximity to cranberry cultivation in Massachusetts. Am J Public Health. 1996; 86(9):1289-96.
17. USEPA, Pesticides. Available at: www.epa.gov/pesticides
18. Bernardes M F F, Pazin M, Pereira L C, Dorta D J. Impact of Pesticides on Environmental and Human Health, Toxicology Studies: Andreazza A C and Scola G, IntechOpen, Jul. 8, 2015. DOI: 10.5772/59710.
19. Auteri M, La Russa F, Blanda V, Torina A. Insecticide Resistance Associated with kdr Mutations in Aedes albopictus: An Update on Worldwide Evidences. Biomed Res Int. 2018; 2018:3098575. doi:10.1155/2018/3098575.
20. Liu N. Insecticide resistance in mosquitoes: impact, mechanisms, and research directions. Annu Rev Entomol. 2015 Jan. 7; 60:537-59. doi: 10.1146/annurev-ento-010814-020828.
21. Belinato T A, Martins A J. Insecticide Resistance and Fitness Cost, Insecticides Resistance, 2016. IntechOpen, DOI: 10.5772/61826. Available at: www.intechopen.com/books/insecticides-resistance/insecticide-resistance-and-fitness-cost.
22. Almeida R A, Han B A, Reisinger A J, Kagemann C, Rosi E J. High mortality in aquatic predators of mosquito larvae caused by exposure to insect repellent. Biology Letters, 2018. doi.org/10.1098/rsbl.2018.0526
23. Farnesi L C, et al. Physical features and chitin content of eggs from the mosquito vectors Aedes aegypti, Anopheles aquasalis and Culex quinquefasciatus: Connection with distinct levels of resistance to desiccation. J. Insect Physiol. 2015: 83, 43-52.
24. Bowman L R, Donegan S, McCall P J. Is dengue vector control deficient in effectiveness or evidence?: Systematic review and meta-analysis. PLOS Neglected Tropical Diseases 2016:1-24. doi:10.1371/journal.pntd.0004551.
25. Grand View Research, Inc. Available at: www.grandviewresearch.com.
26. CDC, Antibiotic/Antimicrobial resistance. Available at: www.cdc.gov/drugresistance/index.html.
27. WHO, Antimicrobial resistance. www.who.int/antimicrobial-resistance/en/
28. Alp E, Danami N. Healthcare-associated infections in intensive care units: Epidemiology and infection control in low-to-middle income countries. Journal of Infection in Developing Countries 2015, 9(10):1040-1045.
29. Barrasa-Villar J, Aibar-Remón C, Prieto-Andrés P, Mareca-Doñate R, Moliner-Lahoz J. Impact on Morbidity, Mortality, and Length of Stay of Hospital-Acquired Infections by Resistant Microorganisms. Infectious Disease Society of America 2017, 65(4):644-652.
30. Mathur, P. Prevention of healthcare-associated infections in low- and middle-income Countries: The ‘bundle approach’. Indian Journal of Microbiology 2018, 36(2):155-162.
31. Founou R C, Founou L L, Essack S Y. (2017). Clinical and economic impact of A R in developing countries: A systematic review and meta-analysis. PloS One, 12(12), e0189621. doi.org/10.1371/journal.pone.0189621.
32. XPS Interpretation of Nitrogen, Application Notes. Available at: xpssimplified.com/elements/nitrogen.php.
33. Pokhrel L R, Andersen C P, Rygiewicz P T, Johnson M G. Preferential interaction of sodium over potassium with carboxylate-functionalized silver nanoparticles. Science of the Total Environment 2014, 490:11-18.
34. Pokhrel L R, Dubey B, Scheuerman P R. Impacts of select organic ligands on the colloidal stability, dissolution dynamics and toxicity of silver nanoparticles. Environmental Science & Technology 2013, 47(22): 12877-12885.
35. Pokhrel L R, Dubey B, Scheuerman P R. Natural water chemistry (dissolved organic carbon, pH, and hardness) modulates colloidal stability, dissolution kinetics and antimicrobial activity of silver nanoparticles. Environmental Science: Nano 2014, 1:45-54.
36. Andersen C P, King G, Plocher M, Storm M, Pokhrel L R, Johnson M G, Rygiewicz P T. Germination and early plant development of 10 plant species exposed to TiO₂ and CeO₂ nanoparticles. Environmental Toxicology and Chemistry 2016, 35(9):2223-9; DOI: 10.1002/etc.3374.
37. Ghasemi Siani N, Fallah S, Pokhrel L R, Rostamnejadi A. Natural amelioration of Zinc oxide nanoparticles toxicity in fenugreek (Trigonella foenum-gracum) by arbuscular mycorrhizal (Glomus intraradices) secretion of glomalin. Plant Physiology and Biochemistry 2017, 112:227-238.
38. Ubah C S, Pokhrel L R, Dikin D. Differential effects of monovalent cations and anions on key nanoparticle physico-chemical attributes. Philadelphia ACS Younger Chemists Committee (YCC) Poster Session, Philadelphia, Pa., Apr. 10, 2018.
39. Hsieh C T, Dong-Ying Tzou, Keng-Yen Hsieh and Ken-Ming Yin. Photoluminescence from amino functionalized graphene quantum dots prepared by electrochemical exfoliation method in the presence of ammonium ions. RSC Adv., 2017, 7:18340-18346.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

Lastly, whereas particular embodiments of the present inventive concept have been shown and described, it will be understood that other modifications, substitutions, and alternatives are apparent to one of ordinary skill in the art. Such modifications, substitutions and alternatives can be made without departing from the spirit and scope of the inventive concept, which should be determined from the appended claims, and it will be understood that the appended claims are intended to cover all such modifications and changes as they fall within the true spirit and scope of the present inventive concept.

1. A nanoparticle comprising:
a metal or metal oxide core; and
a surface of the metal or metal oxide core functionalized with a positively charged molecule/polymer coating the surface,
wherein the positively charged molecule/polymer comprises amino (—NH₂) functional groups.

2. The nanoparticle of claim 1, wherein the metal or metal oxide core comprises silver (Ag) and/or the core is nonporous.

3. The nanoparticle of claim 1, wherein the metal or metal oxide core comprises elemental/metallic silver (Ag⁰).

4. The nanoparticle of claim 1, wherein the positively charged molecule/polymer further comprises amide ([C═O]—N) functional groups.

5. The nanoparticle of claim 1, wherein the positively charged molecule/polymer comprises polyethyleneimine (PEI).

6. (canceled)

7. The nanoparticle of claim 1, wherein the nanoparticle has a size in a range of about 1-10 nm.

8-10. (canceled)

11. The nanoparticle of claim 1, wherein the positively charged molecule/polymer coating the surface of the metal or metal oxide core has a uniform thickness of about 0.5-1.5 nm.

12. (canceled)

13. The nanoparticle of claim 1, wherein the nanoparticle has at least one of the following physicochemical properties:
a polydispersity index (PDI) of about 0.3;
a zeta (ζ) potential/surface charge of about +39.4 mV to about +47.8 mV.
an electrophoretic mobility of about 3.157 μm×cm/V×s;
a solution conductivity of about 5 μS/cm to about 122 μS/cm; and
a localized plasmon resonance peak of about 416.5 nm,
or any combination of two or more of these physicochemical properties.

14. The nanoparticle of claim 1, wherein the nanoparticle has an Ag (3d) X-ray photoelectron spectroscopy (XPS) binding energy maximum at about 367.46 eV, a C (1s) XPS binding energy maximum at about 284.76 eV, an N (1s) XPS binding energy maximum at about 398.74 eV, and/or an O (1s) XPS binding energy maximum at about 531.25 eV.

15-18. (canceled)

19. A method of preparing a metal nanoparticle comprising:
(a) subjecting a mixture of metal salt and a molecule/polymer comprising amino (—NH₂) functional groups in a buffered aqueous solution to ultraviolet (UV) light exposure and heat;
(b) adding a reducing agent to the mixture; and
(c) optionally purifying the metal nanoparticle,
to provide a metal nanoparticle, wherein the metal nanoparticle comprises a metal or metal oxide core and a functionalized surface decorated with a positively charged molecule/polymer coating the surface.

20-22. (canceled)

23. The method of claim 19, wherein the positively charged molecule/polymer of the metal nanoparticle provided further comprises amide ([C═O]—N) functional groups.

24-25. (canceled)

26. The method of claim 19, wherein the metal nanoparticle provided has a size in a range of about 1-10 nm.

27-29. (canceled)

30. The method of claim 19, wherein the positively charged molecule/polymer coating the surface of the metal core has a uniform thickness of about 0.5-1.5 nm.

31-37. (canceled)

38. The method of claim 19, wherein the mixture comprises the molecule/polymer comprising amino (—NH₂) functional groups in a range of about 0.15% to about 0.5% (w/v).

39. The method of claim 19, wherein the metal core comprises silver with zero oxidation state (Ag⁰) in a range about 0.035% to about 0.07% (weight/volume as total silver).

40-50. (canceled)

51. A method of controlling pests comprising applying a pesticidal composition comprising the nanoparticle of claim 1 to the pest, or to a subject, a substrate and/or an environment in which the pest may be found.

52. The method of claim 51, wherein the pest is selected from the group consisting of mosquitos, flies, no-see-ums, beetles, gnats, ticks, beer bugs, fleas, lice/phyllids, bed bugs, earwigs, ants, cockroaches, aphids, spruce bud worms, corn borers, sandfleas, tsetse flies, mites, assassin bugs, silverfish, clothes moths, centipedes, stinkbugs, termites, wasps, hornets, stink bugs, locusts, mormon crickets, aphids, whiteflies, corn rootworms, box elder bugs, caterpillars/larvae to pest lepidoptera, fire ants, ground pearls, millipedes, sow bugs, mole crickets, scale insects, mealybugs, spittlebugs, southern chinch bugs and white grubs.

53. The method of claim 51, wherein the pest is a mosquito of genus Aedes, Anopheles, Coquillettidia, Culex, Culiseta, Mansonia, Ochlerotatus, Psorophora, Toxorhynchites, Uranotaenia, and/or Wyeomyia.

54-55. (canceled)

56. The method of claim 51, wherein applying the pesticidal composition reduces disease transmission through the pest, wherein the disease is Zika, yellow fever, dengue fever, West Nile encephalitis, malaria, Rift Valley fever, arboviral encephalitis, filariasis, babesiosis, ehrlichiosis, Lyme disease, Rocky Mountain spotted fever, Southern tick-associated rash illness, tick typhus, tularemia, Leishmaniasis, Carrion's disease, sand fly fever, African sleeping sickness, Chagas disease, lice infestation, epidemic relapsing fever, trench fever, typhus fever, onchocerciasis, tularemia, anthrax, loiasis, yaws, conjunctivitis, dysentery, typhoid fever, cholera, poliomyelitis, bubonic plague and/or murine typhus.

57. (canceled)

58. A pesticidal composition comprising the nanoparticle of claim 1, wherein the pesticidal composition is non-toxic to off-target organisms.

59. The pesticidal composition of claim 58, wherein the off-target organisms comprise beneficial insect pollinators, small crustaceans/edible shellfish, food crops, feed crops, fiber crops, industrial crops, oil crops, ornamental crops, and fruit trees.

60-61. (canceled)
